(19) United States
(12) Patent Application Publication
(10) Pub. No.: US 2004/0181753 A1
(43) Pub. Date: Sep. 16, 2004

(54) Generic software adapter

(76) Inventor: Phyllis J. Michaelides, Warwick, RI (US)

Correspondence Address: HOWREY SIMON ARNOLD & WHITE LLP, 750 BERING DRIVE, HOUSTON, TX, 77057, US

(21) Appl. No.: 10/385,338

(22) Filed: Mar. 10, 2003

(51) Int. Cl. G09G 5/00

(52) U.S. Cl. 715/523

(57) ABSTRACT

A software adapter is controlled by metadata. For example, templates are provided for receiving information to define a specific adapter for converting a given source format to a given target format. Instead of coding a required data format transformation, the user fills out a template, and the template is stored into a database. The software adapter accesses that information to determine what information is mapped from the source stream to the target stream, and how to transform the mapped information. There is no need to update the information in the database unless there is a change in the source or target format of the mapped information. In a preferred implementation, the software adapter includes an administration tool and graphical user interface, a rule database, a formatting engine, a feed database, and a transformation engine.

### LIMITED COPYRIGHT WAIVER

A portion of the disclosure of this patent document contains computer code listings and display screen templates to which the claim of copyright protection is made. The copyright owner has no objection to the facsimile reproduction by any person of the patent document or the patent disclosure, as it appears in the U.S. Patent and Trademark Office patent file or records, but reserves all other rights whatsoever.

### TECHNICAL FIELD

The present invention relates generally to system connectivity of computer software, and in particular to a flexible software tool for implementing data transformation methods in order to facilitate integration between applications, systems and processes.

### BACKGROUND ART

Over the years, commercial enterprises have used a wide variety of software systems and applications. More recently, commercial software users have recognized a desire to integrate their diverse systems and applications. For example, in a company, there may be hundreds of sites, all using different systems to accomplish the same task, such as preparing a travel and expense report. It is desired to integrate these systems and applications so that the data format of a source stream from one system or application is converted to the data format of a target stream to another system or application. For diverse systems and applications, however, the number of possible interconnections between the data streams increases geometrically as the product of the number of possible source and target streams.

Various techniques have been used to address the software integration problem. One general technique, often referred to as a message broker, operates as an integrator by providing a unique adapter for each application. For example, the unique adapter for each application may translate the source and data stream format of the application to a common format for data exchange, such as a format in hypertext markup language (HTML). However, each adapter in such a system is relatively costly to develop and maintain. Another general technique is to provide an adapter toolkit, which enables a software engineer to develop custom adapters. The drawback of an adapter toolkit is that a relatively skilled person must develop a custom adapter every time an integration issue arises.

### SUMMARY OF THE INVENTION

In the present invention, a software adapter is controlled by metadata. For example, templates are provided for receiving information to define a specific adapter for converting a given source format to a given target format. Instead of coding a required data format transformation, the user fills out a template, and the template is stored into a database. The software adapter accesses that information to determine what information is mapped from the source stream to the target stream, and how to transform the mapped information. There is no need to update the information in the database unless there is a change in the source or target format of the mapped information. In this way, the user does not have to rely on a specific system, but instead can pick and choose what he or she wants.

In accordance with one aspect, the invention provides a software adapter for transforming source data in a source data format to target data in a target data format. The software adapter includes a graphical user interface for obtaining from the user a plurality of rules specifying how to transform the source data from the source data format to the target data in the target data format. The graphical user interface is programmed for obtaining the rules from the user by presenting to the user a series of templates that are filled in by the user. The software adapter further includes a rule database coupled to the graphical user interface for storing the rules, and at least one engine coupled to the rule database for accessing the rule database for interpreting the rules in order to transform the source data in the source data format to the target data in the target data format.

In accordance with another aspect, the invention provides a software adapter for transforming source data in a source data format to target data in a target data format. The software adapter includes a graphical user interface for obtaining from the user a plurality of rules specifying how to transform the source data from the source data format to the target data in the target data format. The software adapter also includes a rule database coupled to the graphical user interface for storing the rules, and a transformation engine coupled to the rule database for accessing the rule database for interpreting the rules. The software adapter further includes a feed database for storing a specification of the source data format and a specification of the target data format, and a transformation engine coupled to the feed database and the formatting engine for transforming the source data in the source data format to the target data in the target data format in accordance with the specification of the source data format, the specification of the target data format, and the rules.

In accordance with yet another aspect, the invention provides a program storage device containing a program executable by at least one data processor for transforming source data in a source data format to target data in a target data format. The program is executable for obtaining from the user a plurality of rules specifying how to transform the source data from the source data format to the target data in the target data format. The program is executable for obtaining the rules from the user by presenting to the user a series of templates that are filled in by the user. The program also is executable for storing the rules in a rule database, and for accessing the rule database for interpreting the rules in order to transform the source data in the source data format to the target data in the target data format.

In accordance with yet another aspect, the invention provides a program storage device containing a program executable by at least one data processor for transforming source data in a source data format to target data in a target data format. The program also is executable for obtaining from the user a specification of the source data format and a specification of the target data format, and for obtaining from the user a plurality of rules specifying how to transform the source data from the source data format to target data in the target data format. The program further is executable for transforming the source data in the source data format to the target data in the target data format in accordance with the specification of the source data format, the specification of the target data format, and the rules.

In accordance with still another aspect, the invention provides a method of transforming source data in a source data format to target data in a target data format. The method includes obtaining from the user a plurality of rules specifying how to transform the source data from the source data format to the target data in the target data format. The rules are obtained from the user by presenting to the user a series of templates that are filled in by the user. The method also includes storing the rules in a rule database, and operating at least one data processor for accessing the rule database for interpreting the rules in order to transform the source data in the source data format to the target data in the target data format.

In accordance with yet still another aspect, the invention provides a method of transforming source data in a source data format to target data in a target data format. The method includes obtaining from the user a specification of the source data format and a specification of the target data format, and obtaining from the user a plurality of rules specifying how to transform the source data from the source data format to the target data in the target data format. The method further includes operating at least one data processor for transforming the source data in the source data format to the target data in the target data format in accordance with the specification of the source data format, the specification of the target data format, and the rules.

In accordance with a final aspect, the invention provides a software adapter for transforming source data in a source data format to target data in a target data format. The software adapter includes input means for obtaining from the user a specification of the source data format, a specification of the target data format, and a plurality of rules specifying how to transform the source data from the source data format to the target data in the target data format. The software adapter also includes a memory for storing the specification of the source data format, the specification of the target data format, and the rules. The software adapter further includes at least one processor coupled to the memory for transforming the source data in the source data format to the target data in the target data format by accessing the memory and interpreting the rules in accordance with the specification of the source data format and the specification of the target data format.

### BRIEF DESCRIPTION OF THE DRAWINGS

Other objects and advantages of the invention will become apparent upon reading the following detailed description in view of the drawings, in which:

FIG. 1 is a block diagram showing a generic software adapter of the present invention being used to integrate diverse software in a business enterprise;

FIG. 2 is a block diagram showing a data processing network programmed with the software of FIG. 1;

FIG. 3 shows a specific example of how the generic software adapter has been tested in a business enterprise;

FIG. 4 shows how the test system of FIG. 3 is intended to be modified to accommodate an additional system source feed;

FIG. 5 shows how the test system of FIG. 3 is intended to be modified to accommodate an additional system target feed;

FIG. 6 is a functional block diagram of a preferred implementation of the generic software adapter;

FIG. 7 is a flowchart of a user input process using the graphical user interface of the generic software adapter;

FIG. 8 is an example of a source or target file specification;

FIG. 9 shows a flowchart of user interaction with the graphical user interface (GUI) of the generic software adapter;

FIG. 10 shows a flowchart of user interaction with the graphical user interface (GUI) to create a new feed;

FIG. 11 shows a number of records comprising a feed;

FIG. 12 is a table listing various kinds of field rules;

FIG. 13 shows a screen of the graphical user interface (GUI) displaying target feeds and source feeds recognized by the generic software adapter;

FIG. 14 shows a template on a new target configuration page;

FIG. 15 shows a template on a filter configuration page;

FIG. 16 shows an empty feed summary page;

FIG. 17 shows a feed summary page with an empty header record;

FIG. 18 shows a new field configuration template;

FIG. 19 shows a template on an alpha-numeric formatting page;

FIG. 20 shows a template on a numeric formatting page;

FIG. 21 shows a template on a data formatting page;

FIG. 22 shows a template on a data source entry page;

FIG. 23 shows a mapping rule screen;

FIG. 24 shows a template on a constant rule page;

FIG. 25 shows a template on a concatenation rule screen;

FIG. 26 shows a template on a conditional rule page;

FIG. 27 shows a template on a substring rule page;

FIG. 28 shows a template on a balance sum field rule screen;

FIG. 29 shows a template on a math rule processing screen;

FIG. 30 shows a feed summary page listing fields of a source feed;

FIG. 31 shows an import target screen;

FIG. 32 shows a user search screen;

FIG. 33 shows a user add/edit screen; and

FIG. 34 shows a hierarchy of objects in Java (Trademark) programming of the generic software adapter.

While the invention is susceptible to various modifications and alternative forms, a specific embodiment thereof has been shown in the drawings and will be described in detail. It should be understood, however, that it is not intended to limit the invention to the particular form shown, but on the contrary, the intention is to cover all modifications, equivalents, and alternatives falling within the scope of the invention as defined by the appended claims.

### DESCRIPTION OF THE PREFERRED EMBODIMENT

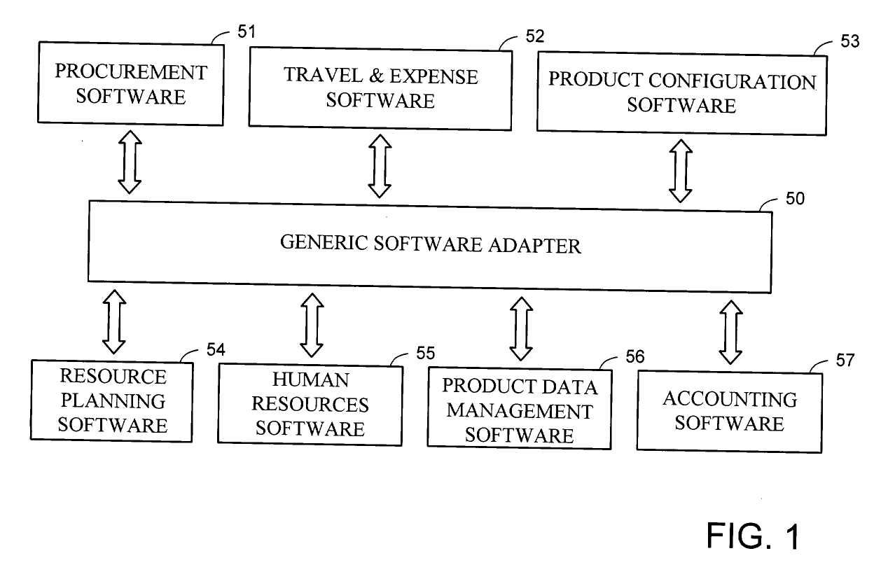

With reference to FIG. 1, there is shown a generic software adapter 50 of the present invention integrating diverse software modules 51, 52, 53, 54, 55, 56, 57 in a business enterprise. The diverse software modules include, for example, procurement software 51, travel & expense software 52, product configuration software 53, resource planning software 54, human resources software 55, product data management software 56, and accounting software 57. The generic software adapter 50 has the capability of transferring information from specifically one application to specifically another application in an unrelated system. The software adapter 50 is generic in the sense that the knowledge and requirements of the source and target of the information transfer are stored in a knowledge base separate from the facility for transferring the information. Therefore, the facility for transferring the information can be adapted or re-used for specific (source, target) pairs by appropriate modification of the knowledge base.

In a preferred implementation, the generic software adapter 50 provides a highly flexible transformation vehicle designed to enable system connectivity. It can rapidly deploy repeatable data transformation methods that facilitate integration between applications, systems, and processes. It can provide data distribution, synchronization, transformation, migration, and consolidation. For example, it can distribute travel expense data to multiple general ledger systems. Then the target general ledger systems are able to function independently without cross company data-delivery dependencies. The preferred generic software adapter 50 can synchronize customer master files between multiple customer relations management applications. It can transform field service data into inventory and work order transactions. It can migrate data from legacy systems to new systems during system upgrades. Such pre-migration data-manipulation tasks have often been costly and inefficient. The preferred generic software adapter 50 can consolidate multiple general ledgers into a single accounting system.

The preferred generic software adapter 50 can be maintained by an end user having a minimal level of technical expertise, resulting in a low resource cost. The generic data integration is not bounded by the specific system, platform or process supporting the generic software adapter 50. Instead, the preferred generic software adapter 50 aggregates and standardizes integration into a single system process. Object-oriented architecture of the preferred generic software adapter 50 provides for re-usable rules, configurations and processes. The modular design facilitates low-cost product customizations and enhancements. The generic software adapter 50 also provides centralized system administration supporting distributed business administration.

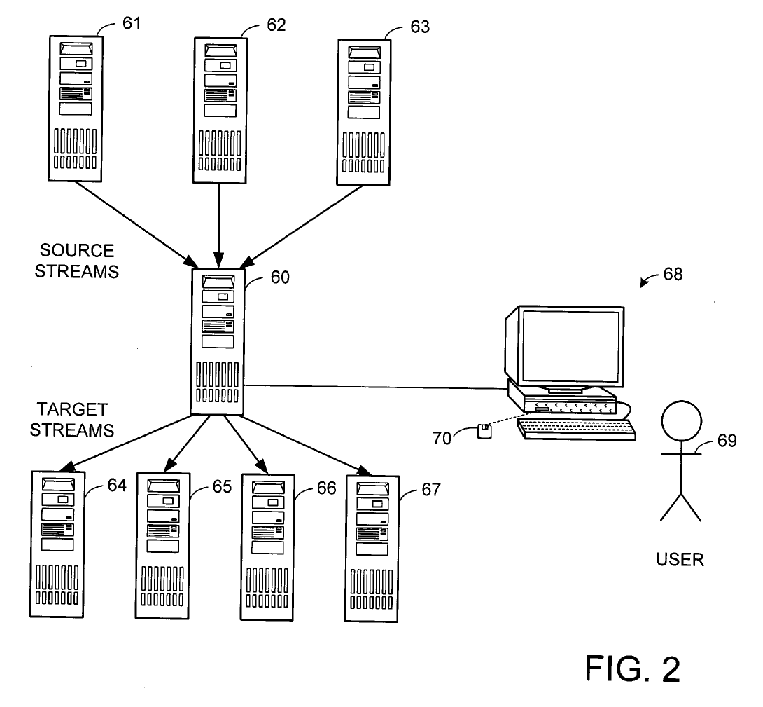

FIG. 2 shows a data processing network programmed with the software of FIG. 1. In this example each item of software 50, 51, 52, 53, 54, 55, 56, 57, resides in a respective network server 60, 61, 62, 63, 64, 65, 66, 67. The servers 61, 62, 63 produce respective source data streams exported from the respective software items 51, 52, 53 to the server 60 supporting the generic software adapter, and the servers 64, 65, 66, 67 receive respective target streams from the server 60 that are imported to the respective software items 54, 55, 56, 57. The server 60 supporting the generic software adapter also acts as a web server for a web browser (such as the Microsoft Explorer (Trademark) or Netscape Navigator (Trademark)) in the work station 68 of a user 69.

The work station 68 functions as part of a graphical user interface for the generic software adapter, by displaying extensible markup language (XML) web pages to the user 69. The work station 68 may also be used for administrative functions, such as control of user access privileges, and programming of the server 60. For example, the generic software adapter program is initially stored on a floppy disk 70 or some other kind of program storage device, such as an optical disk, which is read by the work station 68. The generic software adapter program is then written from the work station 68 to storage in the server 60, and executed on the server 60.

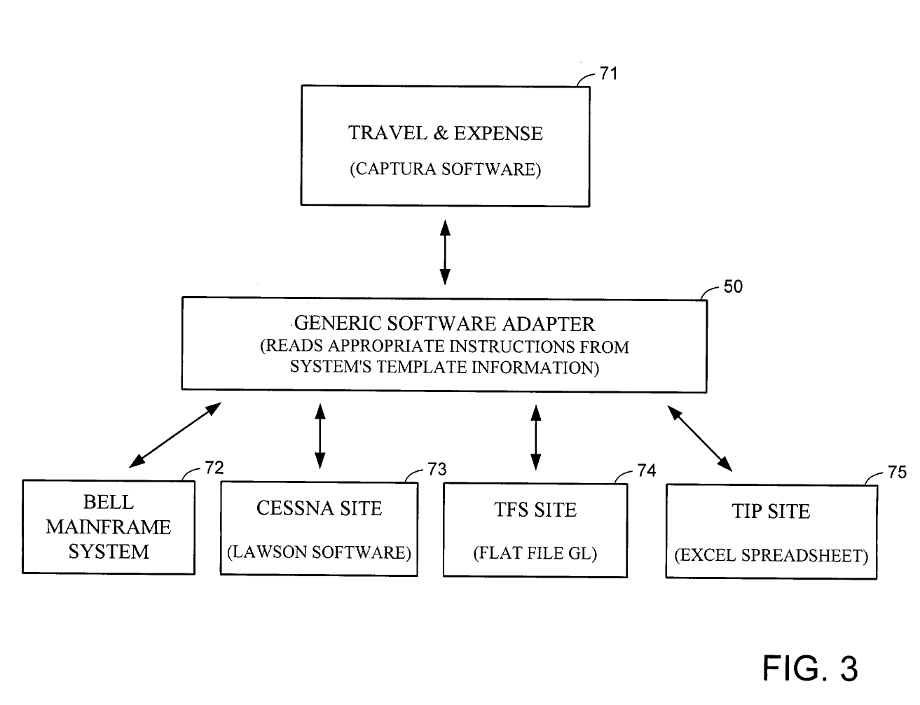

FIG. 3 shows a specific example of how the generic software adapter 50 has been tested in a business enterprise at Textron Corporation. A Captura Software travel and expense application provided a source data stream to the generic software adapter 50. The generic software adapter transformed the source data stream to a respective target data stream to a Bell mainframe system, a site for the Cessna division of Textron using enterprise software by Lawson Software Corp., a site for TFS Technology Corp. general ledger (GL) flat files, and a site for TIP Corp. software using an Excel (Trademark) spreadsheet.

In the configuration of FIG. 3, the generic software adapter 50 reads instructions from stored template information defining a source feed from the Captura software 71 and defining respective target feeds to the Bell mainframe system 72, the Lawson Software enterprise software at the Cessna site 73, the GL flat files at the TFS Technology Corp. site 74, and the TIP Corp. site Excel spreadsheet 75. The respective template information for each target software system or application also includes rules for each target feed that define how data for the target feed are obtained from the source feed.

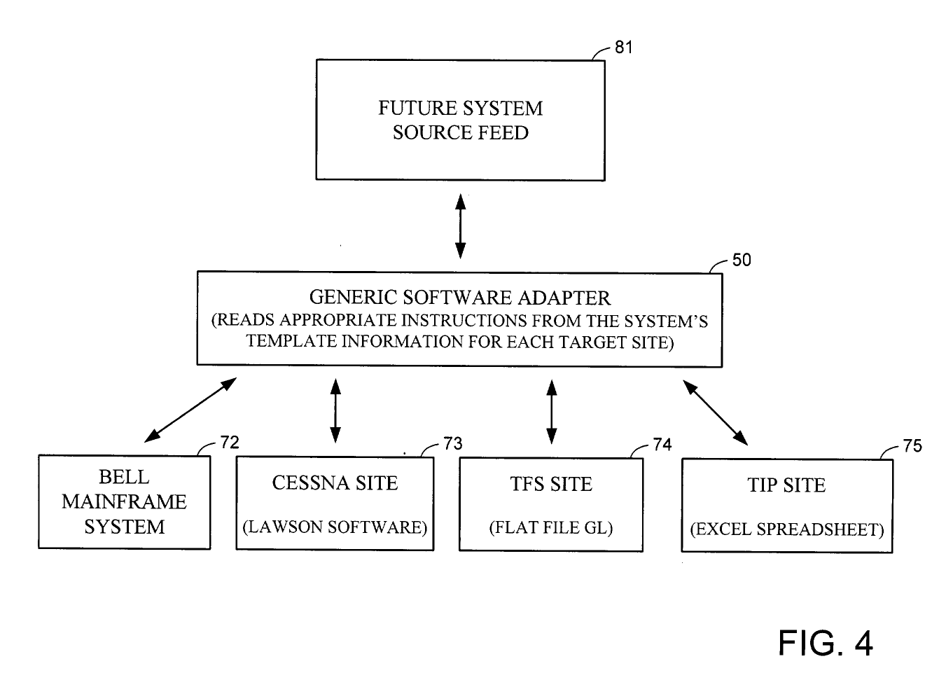

FIG. 4 shows how the test system of FIG. 3 is intended to be modified to accommodate an additional source feed from a future system 81. In this case, the template information for the old source feed (of the Captura software site 71 in FIG. 3) is modified to provide new template information defining a new source feed defining the data format of the future system 81. Moreover, existing rules for each of the target feeds may need to be modified or augmented to define how data for each of the target feeds are obtained from the source feed of the future system 81.

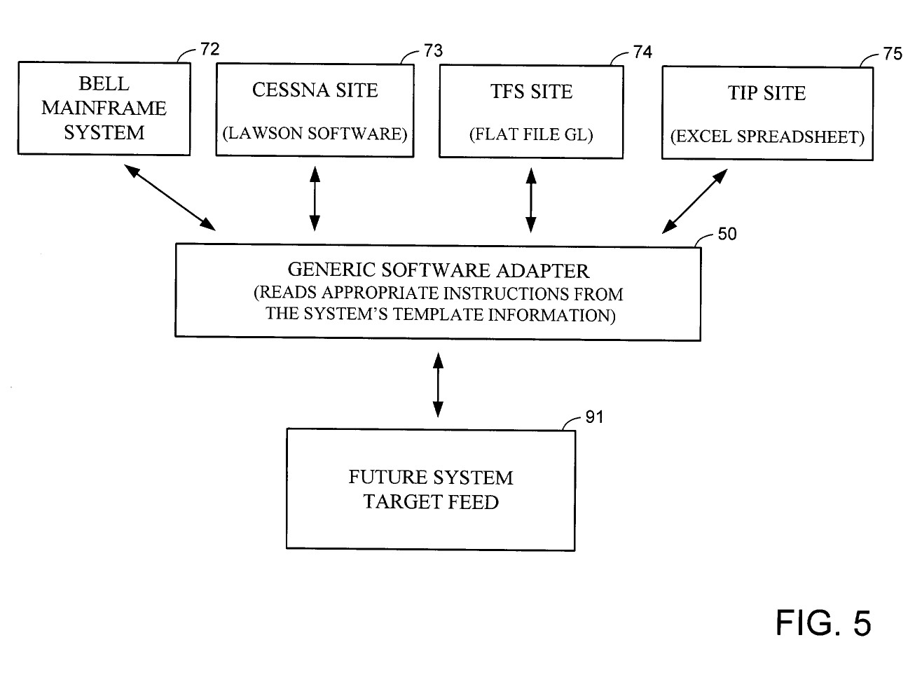

FIG. 5 shows how the test system of FIG. 3 is intended to be modified to accommodate an additional system target feed 91. In this case, old template information of one of the old sites is modified to provide new template information defining the data format of the system target feed 91 and rules defining how data for the system target feed are obtained from the source feeds.

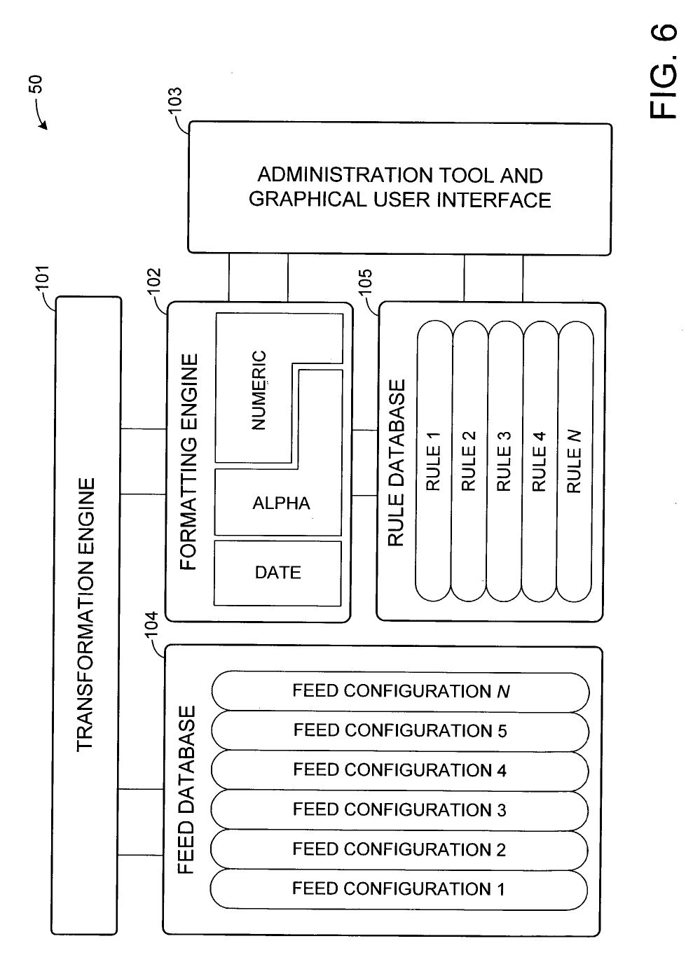

FIG. 6 shows functional blocks of the generic software adapter 50. The generic software adapter 50 includes a transformation engine 101, a formatting engine 102, an administration tool and graphical user interface 103, a feed database 104, and a rule database 105. The transformation engine 101, the formatting engine 102, and the administration tool and graphical user interface 103 are programs executed by at least one processor, such as a processor in the server 60 in FIG. 2. The feed database 104 and the rule database 105 are data structures that reside in memory, such as memory in the server 60 in FIG. 2. The transformation engine 101 controls the data transformation functions, and it is designed to integrate within existing integration processes. The formatting engine 102 allows the end-user to format data in virtually infinite combinations. This eliminates integration barriers caused by differing data formats across multiple systems, including mainframe systems. The administration tool and graphical user interface 103 is a web-based tool that allows business and technical users to configure integration and data transformation requirements. The administration tool 103 has security features in order to restrict user access to appropriate settings. The feed database 104 provides a centralized repository for all integration solutions. This facilitates an enterprise-wide, standardized, centralized integration process, security model, and administration model. The formatting engine 102 interprets the rules in the rule database 105. The transformation engine 101 accesses active feed configurations in the feed database 104 and is coupled to the formatting engine 102 in order to transform data from the source data formats (specified by source feed configurations) to the target data formats (specified by the target feed configurations). The rule database 105 allows for easy implementation of new rules as well as reuse of rules across different projects, departments, and businesses.

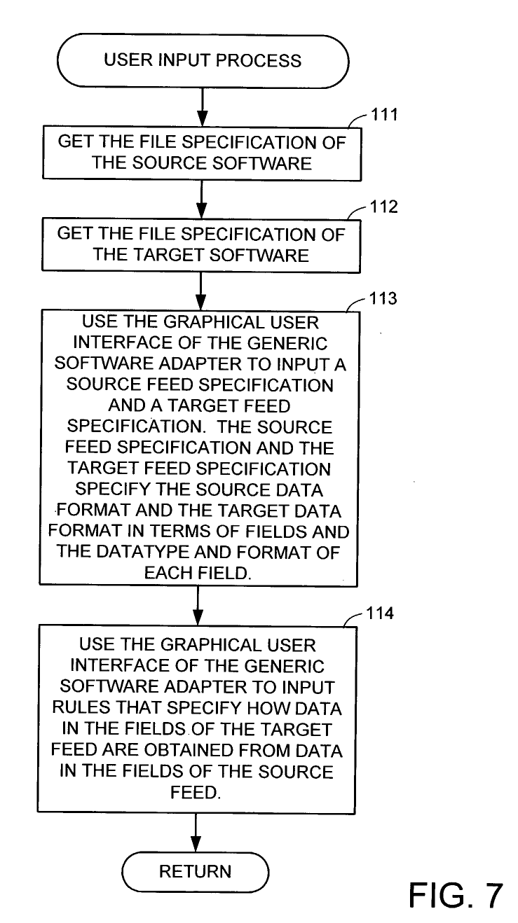

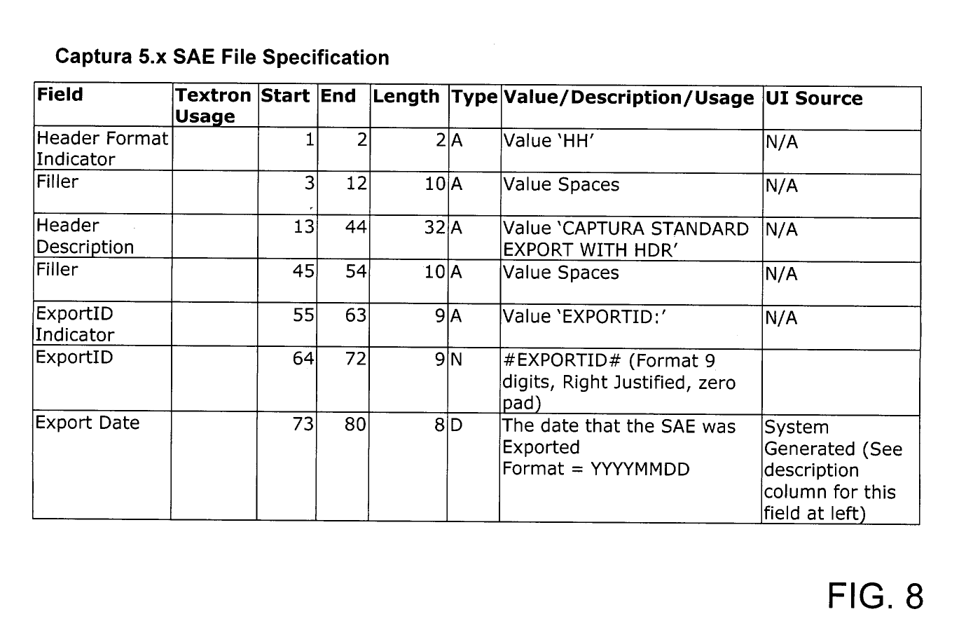

FIG. 7 shows the user input process using the graphical user interface (GUI) of the generic software adapter. In a first step 111, the user obtains a file specification of the source software. The file specification indicates the usage and format of a series of fields in a file of the source software. For example, FIG. 8 shows a file specification of the first seven fields for a file in the Captura software. In the best case, the software vendor will provide the file specification. In many cases, the file specification is evident from inspection of source code, such as data structure definitions or input/output statements defining the file format. In the worst case, such as legacy software from a defunct software vendor, the file specification is obtained by reverse engineering including inspection of sample files.

In step 112 of FIG. 7, the user obtains a file specification of target software. Then in step 113, the user uses the graphical user interface (GUI) of the generic software adapter to input a source feed specification and a target feed specification. The source feed specification and the target feed specification specify the source data format and the target data format in terms of fields and the datatype and format of each field. For example, Appendix I to this specification includes the XML specification of the Captura software source feed corresponding to the file specification of FIG. 8. Finally, in step 114, the user uses the graphical user interface of the generic software adapter to input rules that specify how data in the fields of the target feed are obtained from data in the fields of the source feed.

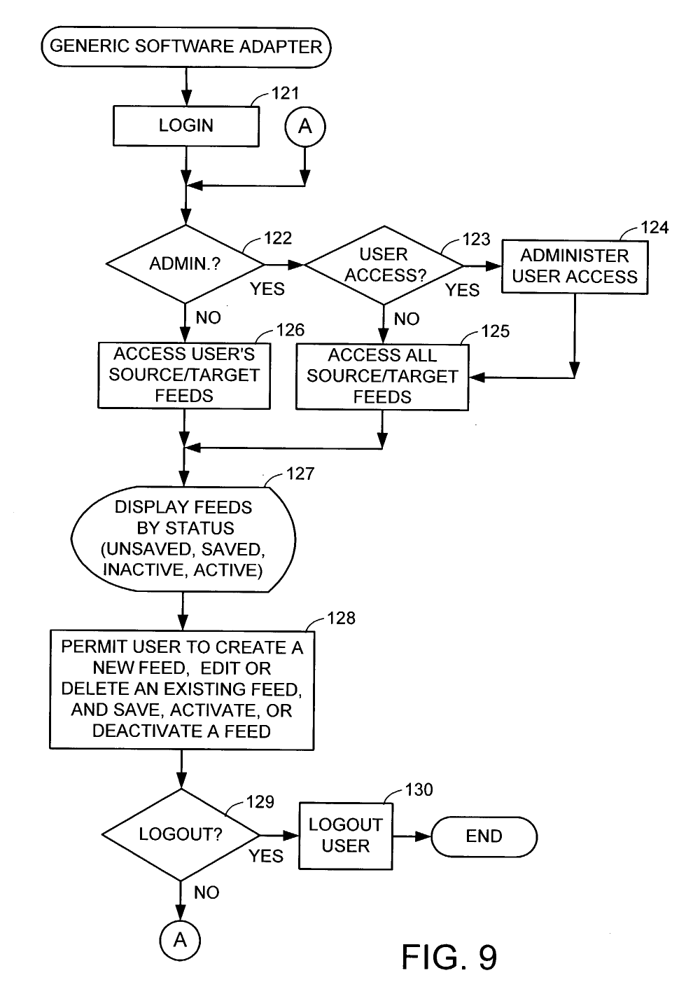

FIG. 9 shows a flowchart of user interaction with the generic software adapter GUI. In a first step 121, the user logs in to the generic software adapter. If the user is an administrator, then execution branches from step 122 to step 123. In step 123, if the administrator desires to administer user access, then execution branches to step 124 to administer user access. Execution continues from step 123 or step 124 to step 125. In step 125, the generic software adapter GUI enables the administrator to access all source and target feeds defined in the database of the generic software adapter. Otherwise, in step 126, an ordinary user is given access only to source and target fees that have been set up by or for the ordinary user. Execution continues from step 125 and step 126 to step 127.

In step 127, the generic software adapter GUI displays the feeds to the user. Then in step 128, the user is permitted to create a new feed, edit or delete an existing feed, and save, activate, or deactivate a feed. It may be desirable to deny an ordinary user permission to delete any feed, and to give an administrator permission to duplicate feeds. A feed is in an “unsaved” state when it is in memory but not stored in the database. A feed is in an “inactive” state when it is verified but not yet activated. When a source feed is activated, data is read from the source and exported to the target feed. When a target feed is activated, data is imported from the source feed and written to the target.

In step 129, if the user desires to logout, then execution branches to step 130 to log the user out, and finish the interaction between the user and the generic software adapter GUI. Otherwise, execution loops back from step 129 to step 122 to continue the interaction between the user and the generic software adapter GUI.

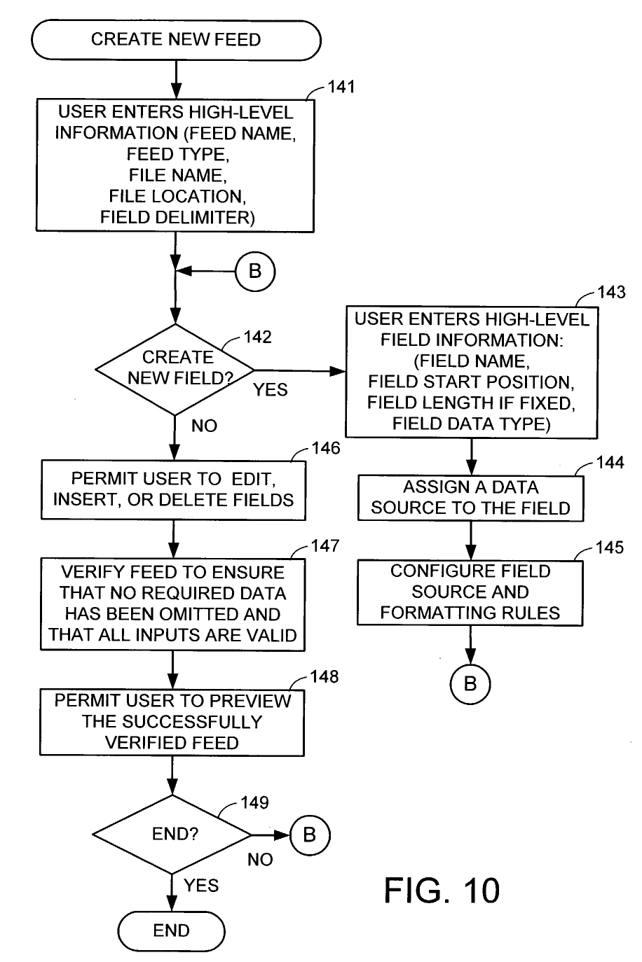

FIG. 10 shows a flowchart of user interaction with the generic software adapter GUI to create a new feed. In a first step 141, the user enters high-level information about the feed, including a feed name, feed type, file name, file location, and field delimiter. The user then creates a series of fields. For each new field, execution branches from step 142 to step 143. In step 143, the user enters high-level field information, including a field name, field start position, field length if fixed, and field data type. The field data type is string (i.e., alphanumeric), number (i.e., numeric), or date (i.e., calendar date). Then in step 144, the user assigns a data source to the field, and in step 145, the user configures field source formatting rules specifying how data from the data source is to be transferred into the field.

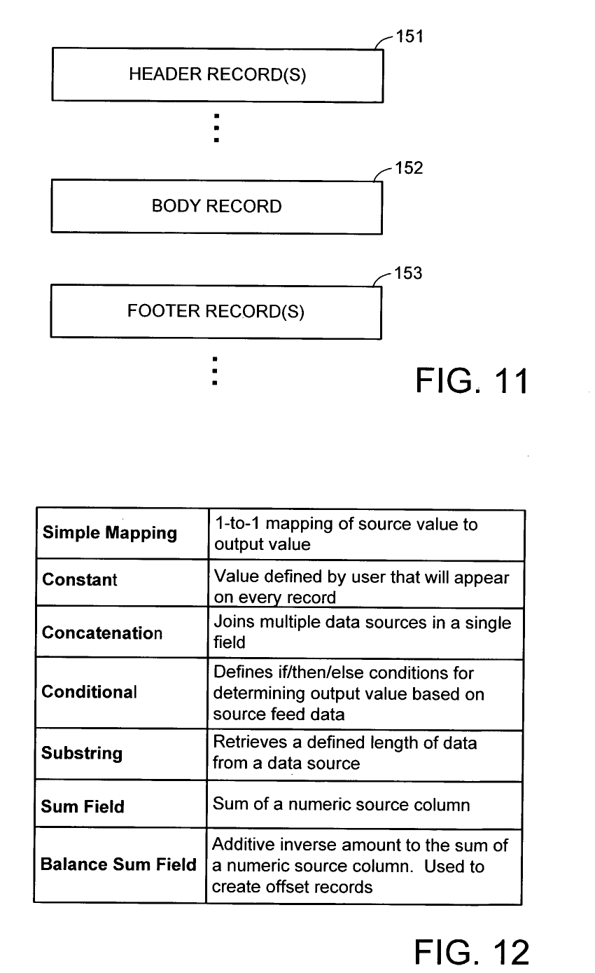

The field rules are described further below with reference to FIG. 11. Data can be retrieved directly from the source feed or it can be processed through a series of the field rules. The rules are hierarchical and can be nested to allow for complex data handling. Rule modules can be plugged into the adapter to expand existing functionality. New rule modules can be plugged in without disrupting existing production processes. Data for a field or for a rule can be a constant value defined by the user or data can be system generated, such as a system date, or a row count or a total number of rows in a table in a source file. The field formatting is dependent on the field data type. The generic software adapter assigns default values to fields but the user can override these default values.

After step 145, execution loops back to step 142. The user can create additional new fields, and in step 146 the user is permitted to edit, insert (i.e., re-order), or delete the fields. New fields can be added to the end of a field list or inserted between existing fields.

In step 147, the generic software adapter verifies the feed to ensure that no required data has been omitted and that all inputs are valid. Then in step 148 the user is permitted to preview the successfully verified feed. A preview can be saved and run through a target system as a test. If the user is satisfied with the new feed, the user can choose in step 149 to end the task of creating the new feed, or otherwise loop back to step 142 to continue the task.

In a preferred feed format, as shown in FIG. 11, a feed includes one or more header records 151, one body record 152, and one or more footer records 153. Each record includes one or more fields. The header and footer records can be used to generate summary data or offset records.

FIG. 12 shows a table of the various field rules. A simple mapping rule defines a 1-to-1 mapping of source value to output value. A constant rule specifies a user-defined value that will appear in every record. A concatenation rule joins multiple data sources in a single field. A conditional rule defines an if/then/else condition for determining an output value based on source feed data. A substring rule retrieves a defined length of data from a data source. A sum field rule defines the sum of a numeric source column. A balance sum field rule specifies an additive inverse amount to the sum of a numeric source column. Balance sum field rules are used to create offset records. These rules are further described below with reference to the templates shown in FIGS. 22 to 28.

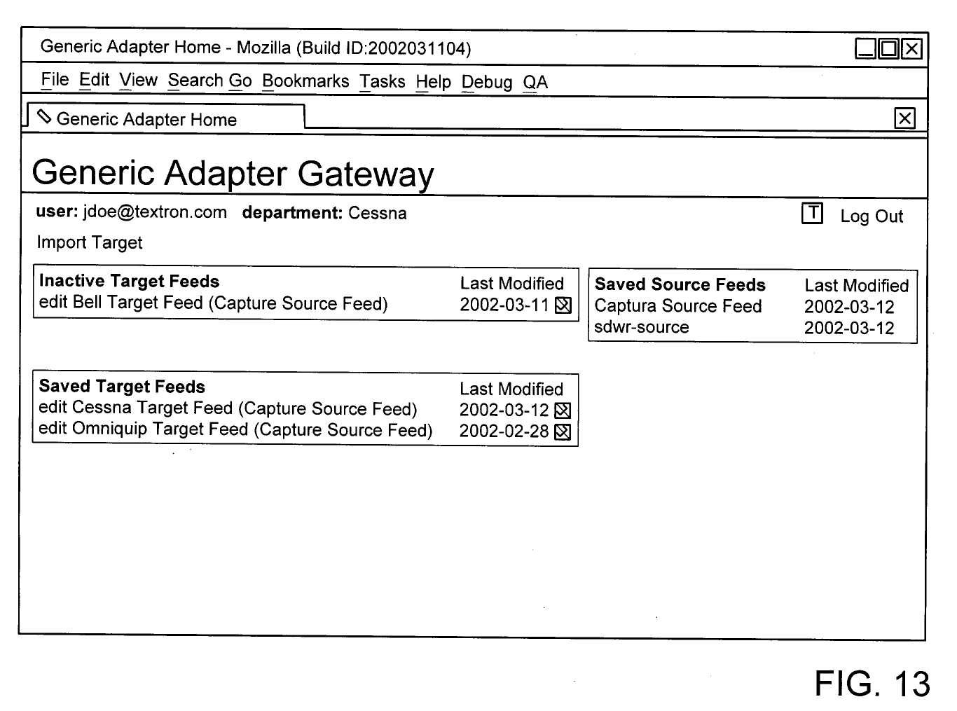

FIGS. 13 to 33 show a series of screens or templates displayed to the user by the graphical user interface (GUI) of a preferred embodiment of the generic software adapter. To access the generic software adapter, the user enters a web address of the generic software adapter into a web browser. The GUI responds by prompting the user for a user name and a user password. When the user provides a valid user name and password, the GUI displays the generic adapter home page as shown in FIG. 13. This generic adapter home page provides a summary of the source and target feeds. If the user has permission to edit a feed, then the word “edit” appears just before the listing of the name of the feed, and the user can use a mouse to click on this word “edit” in order to edit the feed.

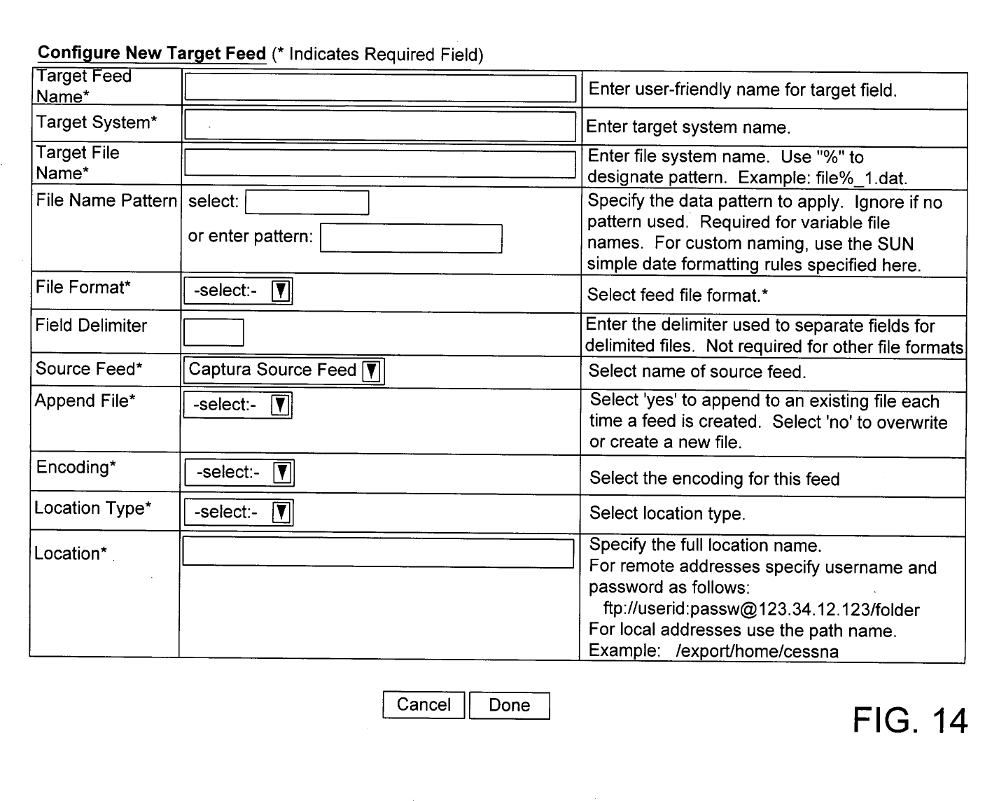

In order to create a new target feed, the user clicks on a new target template button, appearing in the mid-upper right of the screen as a small rectangular box enclosing the letter “T”. The GUI responds by displaying a screen including a “Configure New Target Feed” template as shown in FIG. 14. The user fills in this template to provide high-level information about the target feed. The fields of this template include the following:

Target Feed Name: A name that uniquely identifies this feed.

Target System: The name of the system to which this feed will be sent. This is just for informational purposes.

Target File Name: The name of the file that will be produced when this target feed is processed. If users wish to have the file name date stamped, the user inserts the % character into the filename where they wish to have the date stamp.

File Name Pattern: The pattern for the date stamp. For example, MMddyyyy would produce the two-digit month, two-digit day, and four-digit year. A filename of test%.dat run on Mar. 14, 2002 would produce the file test03142002.dat.

File Format: Users can have their file be fixed-width or delimited. Fixed width means that users determine the size of each field, and there are no delimiters. Delimited means that field width can vary from record to record, and each field is separated by a delimiter character.

Field Delimiter: This is only required for delimited files. This is the character or characters that separate each field.

Source Feed: This is the source feed that this target data will come from.

Append File: Whether or not each night's processing should be appended to the existing file, or should overwrite it.

Encoding: The file encoding that the target file should use. ASCII is the default file encoding. The file encoding can also be Unicode (a 16 bit character format that allows for extended characters) or EBCDIC (a file format predominant in IBM mainframe systems).

Source Feed: This is the source feed that this target data will come from.

Location Type: If a user chooses local, then that indicates that the user will be picking up the file via the File Transfer Protocol (FTP). Remote indicates that the feed will be pushed out to a remote location.

Location: This is the directory on the generic adapter server where the feed should be placed. This information can be obtained from the generic adapter administrator.

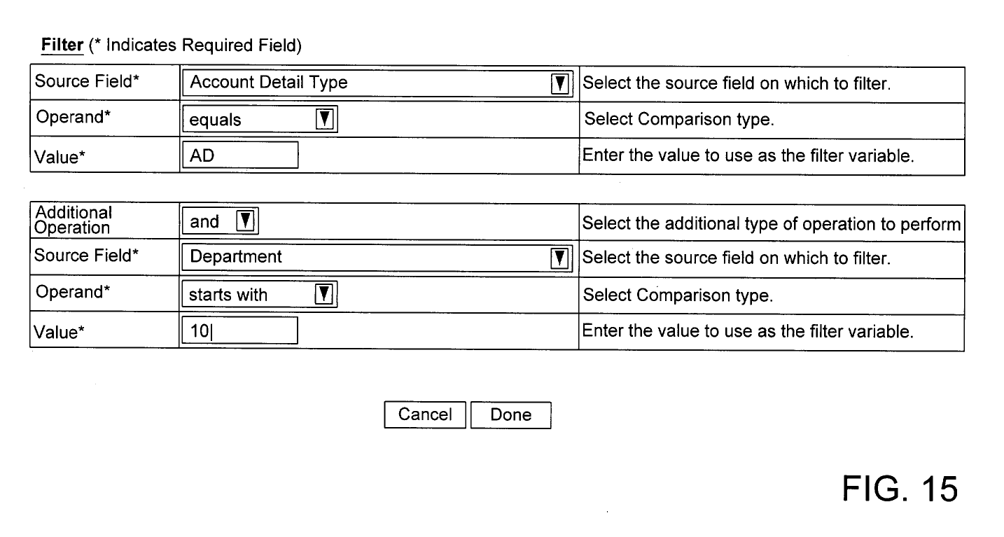

Selecting “Done” at the bottom center of the template will submit the target feed information, and then the GUI will display a filter page including a filter template as shown in FIG. 15.

In the filter template of FIG. 15, the user can choose filtering of the records coming in from the source feed using one or two criteria. If a user has only one criterion, then the user enters it in the top three fields. If a user has two criteria, then the user fills in both the top and bottom sets of fields, and picks an additional “AND” or “OR” operation. If the additional operation is “AND”, then only records meeting both criteria will be returned. If the additional operation is “OR”, then records meeting either criterion will be returned. The field descriptions are:

Source Field: The source field on which the user wishes to filter.

Operand: Can be equals, not equals, or starts with.

Value: The value used for the comparison. In the example shown in FIG. 15, the records returned must have “AD” in the Account Detail Type field and a Department value starting with “10”. Although applying a filter is not required, if use of a filter is desired, then all the required fields must be completed.

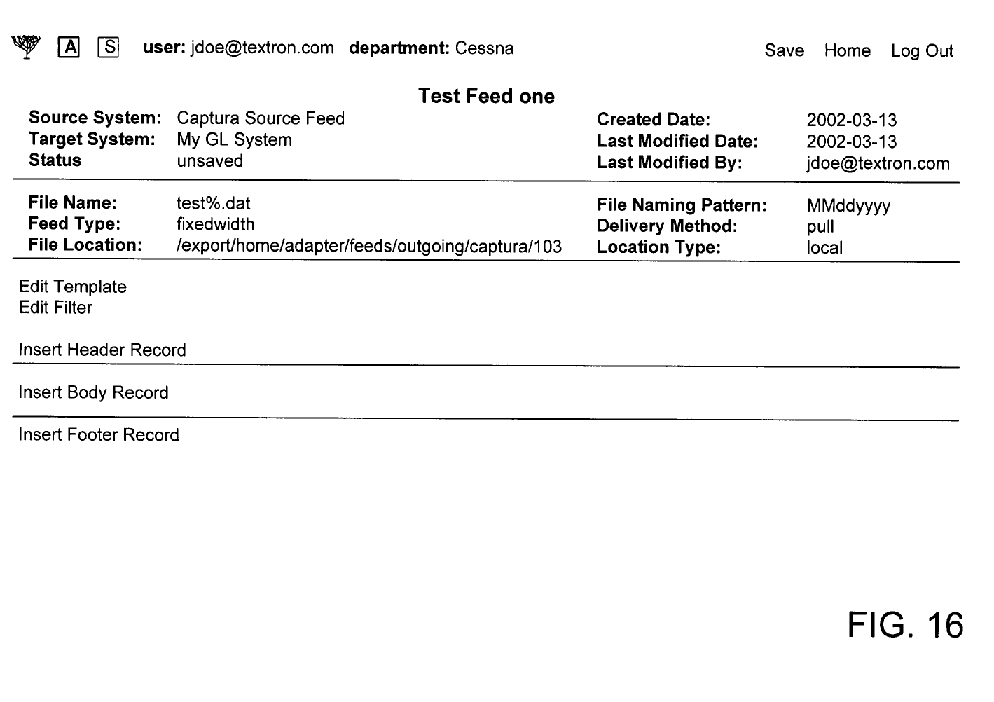

Selecting “Done” will submit the target feed information, and then the GUI will display a feed summary page including a feed summary template as shown in FIG. 16.

The feed summary template of FIG. 16 displays to the user both high-level feed information as well as the individual fields and field types within the various records of the field. From this page, records and fields can be added, modified or deleted. The primary components of the field summary template are:

Display Navigation Tree Icon: Selecting this icon (in the upper left-hand corner) will open the navigation tree frame, which will assist the user in navigating and editing feeds.

Advanced/Standard View Toggle Icons: Toggling the Standard and Advanced view buttons (to the right of the tree icon, in the upper left-hand corner) modifies the view mode. Some pages have advanced fields hidden so as to simplify the user experience, selecting the advanced mode renders all the fields visible allowing the user to further customize the fields.

Feed Preview Button: The feed preview button allows users to view on screen the output of target feeds. This action is only available for feeds that have been saved and verified.

Save—Save Button: The save button saves the template without attempting to validate it.

Verify—Verify Button: The verify button validates a saved template to ensure that the layout is correct and that all required fields have been correctly completed.

Activate—Activate Button: The activate button updates the status of the field as active indicating that the feed layout is ready for processing.

Deactivate—Deactivate Button: The deactivate button is only available for active fields as a means to indicate that the feed is no longer ready for processing and should not be processed.

Edit Template: The edit template link allows the user to modify the high-level feed layout configuration.

Edit Filter: The edit filter link allows the user to modify the feed filter configuration.

Insert Header/Body/Footer Record: Allow the user to add a record to the feed. Although there can be multiple header and footer records, each feed layout can only have a single body record.

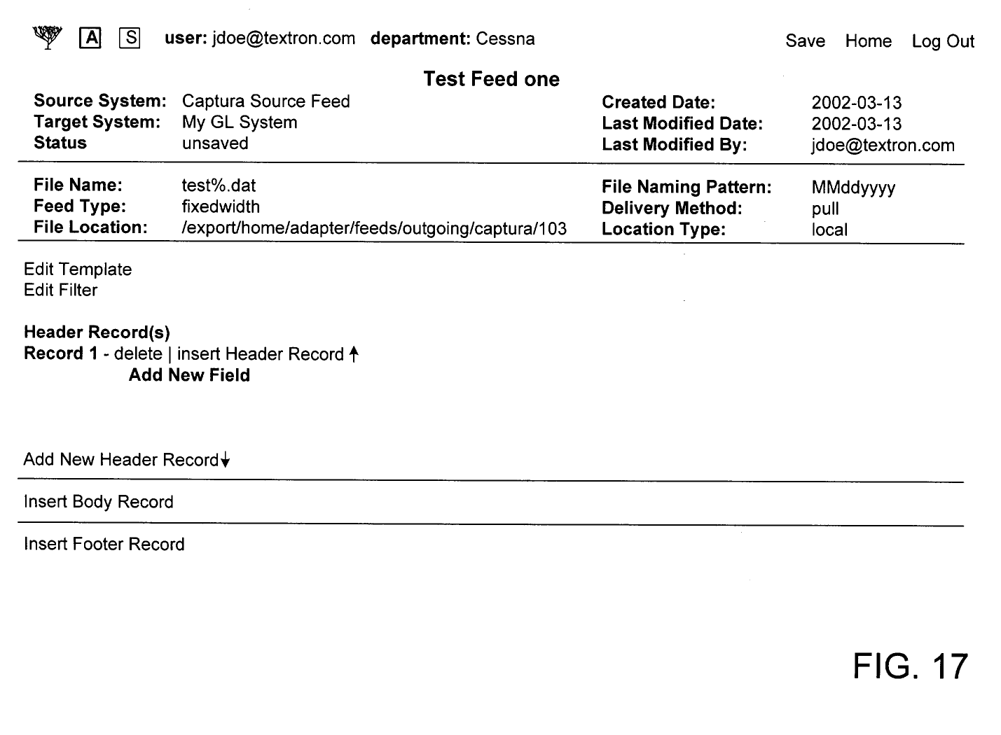

A feed can contain zero, one, or many header records. Header records are generated at the beginning of the feed. This is done by clicking on the “Insert Header Record” link. This will insert an empty header record into the feed, and then the GUI displays the template shown in FIG. 17. The header record remains empty until the user adds a field to it.

A feed can contain zero or one body record layout. Body records are generated following the header records. This is done by clicking on the “Insert Body Record” link. This will insert an empty body record into the feed. The record remains empty until a field is added to it.

A feed can contain zero, one, or many footer record layouts. Footer records are generated at the end of the feed. This is done by clicking on the “Insert Footer Record” link. This will insert an empty footer record into the feed. The record remains empty until a field is added to it.

The next step is to add a field to the header record. For a fixed width feed, the following parameters are required:

Field Name: The name of the field.

Start Position: The position in the header record at which this field should start. To position this field at the beginning of the record, enter 1. To have it start at the 4th position, enter 4.

Field Length: The length of the field. No matter what the length of the data, the field will not be longer than this value.

Data Type: Specifies that the data in this field is either a string value, a numeric value, or a date value. The data type determines the type of formatting that will be added in the next step.

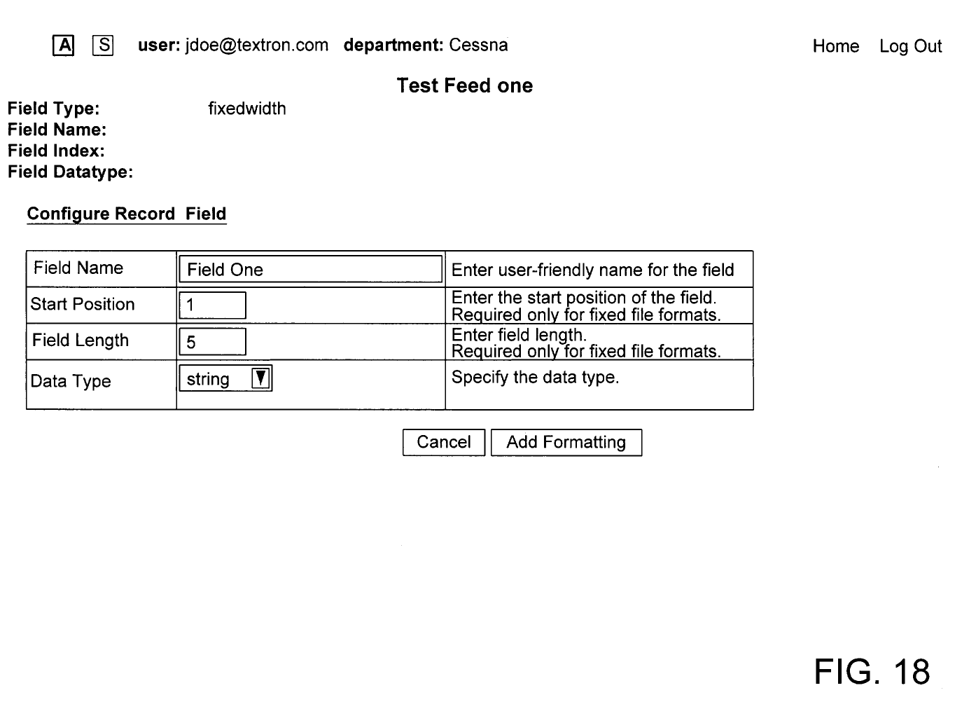

For delimited feeds, only the field name and data type are required. Clicking “Add Field Formatting” will cause the GUI to display the Configure Record Field template shown in FIG. 18.

There are three types of formatting applied to a field depending on whether the data type is string, numeric, or date. By default, users are taken to the Standard view, which presents a limited amount of formatting options. All the fields with the exception of field length are assigned default values so as to speed up entry time and increase usability. If a user wishes to have more control, then the user should click on the “A” button in the upper left-hand corner before entering the field data and clicking on the Add Formatting button.

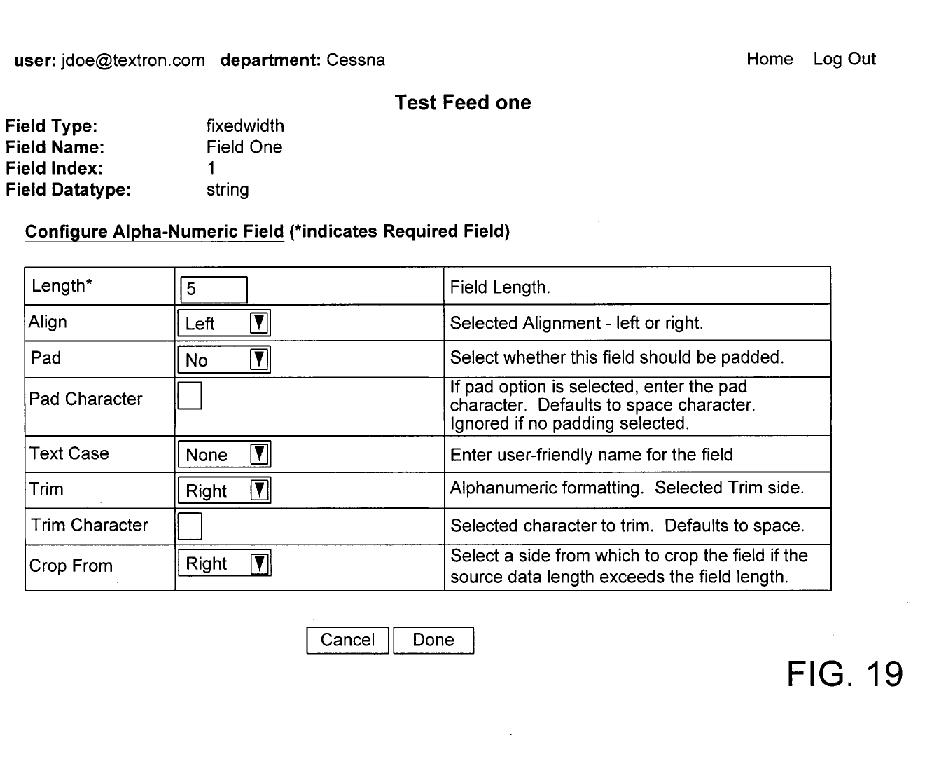

For the string data type, in the advanced view, the GUI displays the Configure Alpha-Numeric Field template, as shown in FIG. 19. This template has the following fields:

Length: The length of the data. This can be used if a user wants to pad the data in a delimited file, or it can be used to truncate data. Typically, though, it is the same as the length of the field.

Align: The alignment of the data in the field. This will determine if padding is applied to the left or to the right of the data.

Pad: Whether or not to pad the data if the data is shorter than the length specified.

Pad Character: If Pad is yes, then this character will be used to fill in the data until it reaches the length specified.

Text Case: This can change the string data to all upper case, all lower case, or leave it alone.

Trim: This allows the user to trim groups of repeated characters from the data from either the left, the right, both sides, or none. The character to trim is specified in the Trim Character field. For example, if a data string was “foo”, Trim was set to Both, and the trim character was “ ” (space), then the resulting string would be “foo”. If the data was “xxxfooxxx”, the trim was set to Left, and the trim character was set to “x”, then the resulting string would be “fooxxx”.

Trim Character: The character used for identifying groups of characters to trim.

Crop From: If the data is longer than the specified length, what side gets cropped away.

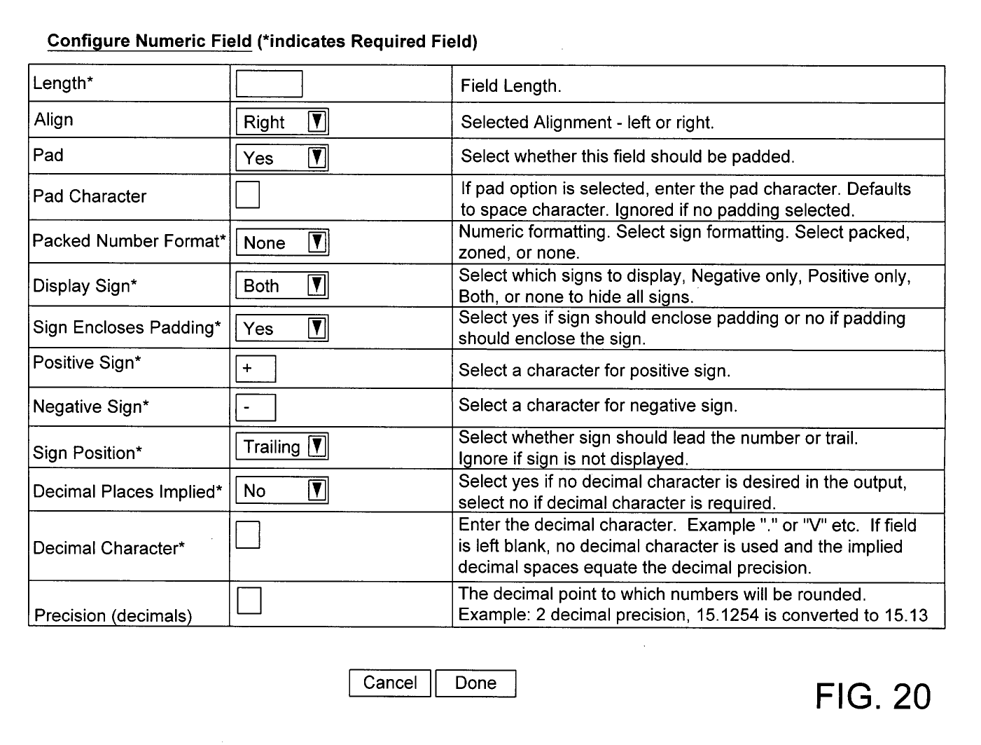

For number formatting, by default, the user is taken to the Standard view, which presents a limited amount of formatting options. All the fields with the exception of field length are assigned default values so as to speed up entry time and increase usability. If the user wishes to have more control, then the user should click on the “A” button in the upper left-hand corner before entering the field data and clicking on the Add Formatting button. This causes the GUI to display the Configure Numeric Field template as shown in FIG. 20. This template has the following fields:

Length: The length of this field. Same as in String formatting.

Align: The alignment of the data in the field. Same as in String formatting.

Pad: Whether or not to pad this data. Same as in String formatting.

Pad Character: The character to use when padding this value. Same as in String formatting.

Packed Number Format: Only for use if the feed's encoding is EBCDIC. Zoned number format is a special way to display numbers.

Display Sign: This indicates which signs to display. To only display signs on negative numbers, choose negative. To only display signs on positive numbers, choose positive. To display signs for both, choose both. To display no signs, choose none.

Sign Encloses Padding: If yes, then the sign character is placed after any padding has been performed. If no, then the padding will happen after the sign is inserted.

Positive Sign: The character to use to indicate a positive number. Negative Sign: The character to use to indicate a negative number.

Sign Position: Choose leading to have the sign before (to the left of) the number, or trailing to have the sign after (to the right of) the number.

Decimal Places Implied: Whether or not decimal places are implied in this number. If yes, the precision value is used to determine the number of implied decimal places. So with a precision of 2, then the number 2003 would be interpreted as 20.03.

Decimal Character: The character to represent a decimal place.

Precision: For all numbers, this indicates the number of places to round the number to. If decimal places are implied, then this also indicates the number of decimal places that are implied.

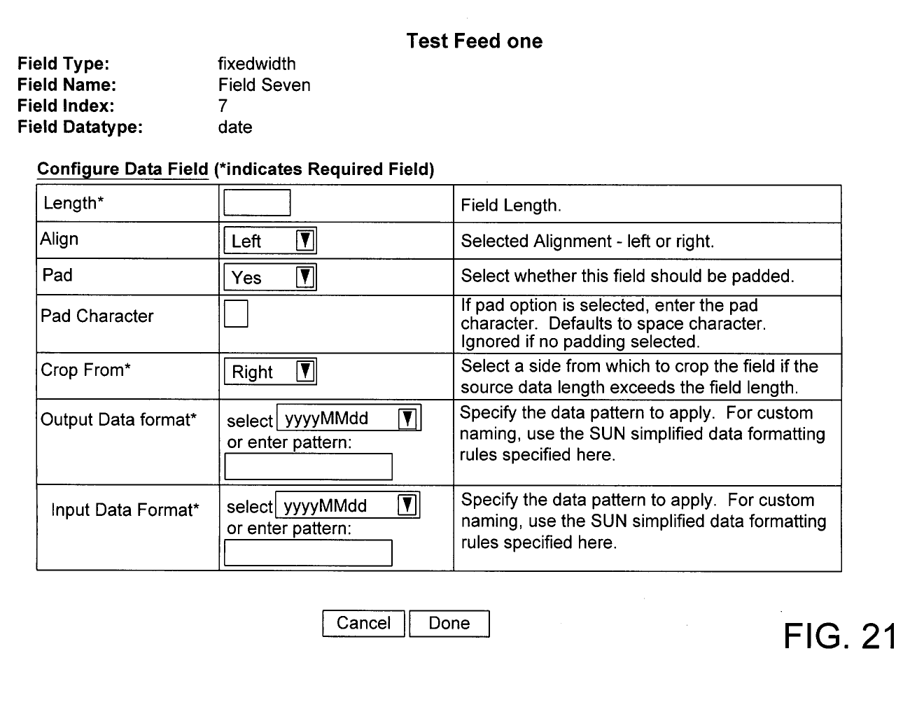

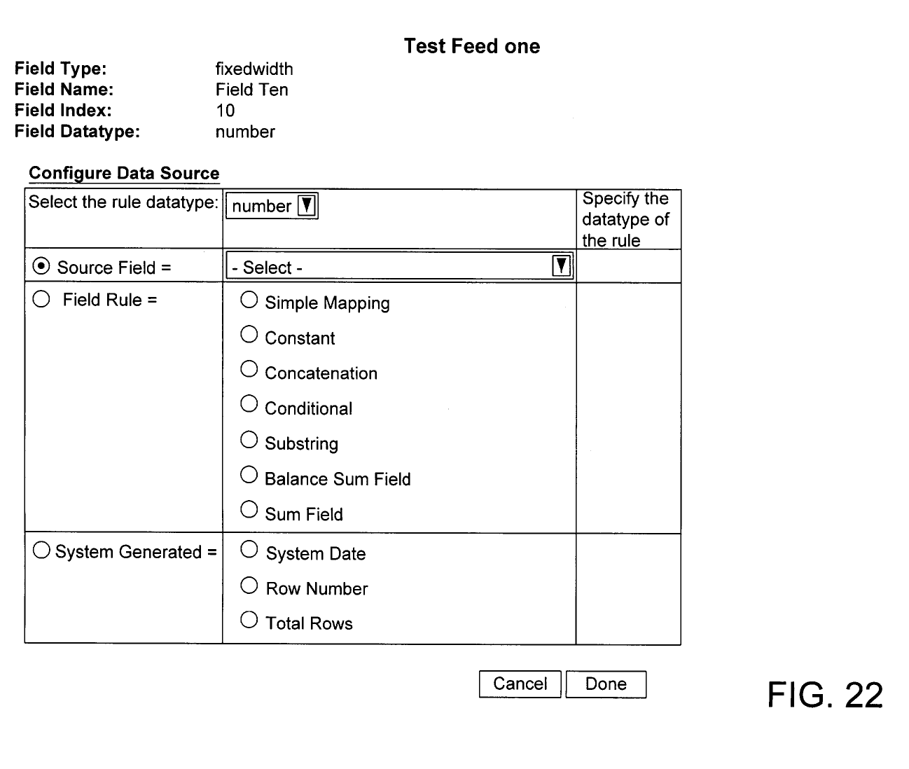

For data formatting, by default, the user is taken to the Standard view, which presents a limited amount of formatting options. All the fields with the exception of field length are assigned default values so as to speed up entry time and increase usability. If a user wishes to have more control, then the user should click on the “A” button in the upper left-hand corner before entering the field data and clicking on the Add Formatting button. This causes the GUI to display the Configure Data Field template, as shown in FIG. 21. This template has the following fields:

Length: The length of the field.

Align: The alignment of the data within the field

Pad: Whether or not the data in the source feed is padded.

Pad Character: What character is used to pad the data.

Input Date Format: The format that the incoming date data is in. This is only required if the data source is of type date. If the source data is a string, the adapter will use the input date format to convert the string date into a date data type.

Output Date Format: The output format of the date. Takes a date pattern as an argument. For a full list of patterns select the link on the screen to the SUN site where date patterns are discussed at length.

Once the field format is configured, the next step is for the user to configure the data source for the field. The field data source can be one of a multiple options. The first step to adding a data source is picking the type of data source. This is done on the Configure Data Source template, as shown in FIG. 13. There are the following three categories of data sources: Source Field, in which data is taken directly from a source feed field; Field Rule, which processes the data prior to output; and System Generated, in which the system rules generate runtime-specific data.

“Source Field” and “System Generated” data sources can be completely configured on the Data Source page. Field Rules require the user to continue to rule-specific pages to configure individual rules. To select any data source, the user selects the desired value on the Configure Data Source template of FIG. 22 and then clicks on “Done” at the bottom of the template.

Data sources can be nested. In fact, many of the Field Rule data sources only perform modifications of data, and thus need data sources of their own. The Configure Data Source template, however, is the same at all levels.

The Source Field of the Configure Data Source template allows the user to bring data directly from the source feed into the target feed. The “-Select-” dropdown contains every field available in the source feed definition. When the target feed is run, each row in the target feed that has a Source Field as its data source will receive the value of the specified field in the corresponding source row. There is no further information required for this data source type, so clicking “Done” takes the user back to the Configure Field template.

The System Generated rules allow users to use data that is not contained in the source feed, but is instead calculated by the generic software adapter. There are three kinds of system generated rules: System Date, which is the date that this feed is being processed; Row Number, which is the current row of data that is being processed; and Total Rows, which is the total number of rows of data that will be in this target feed. There is no further information required for this data source type, so clicking “Done” will take user back to the Configure Field template.

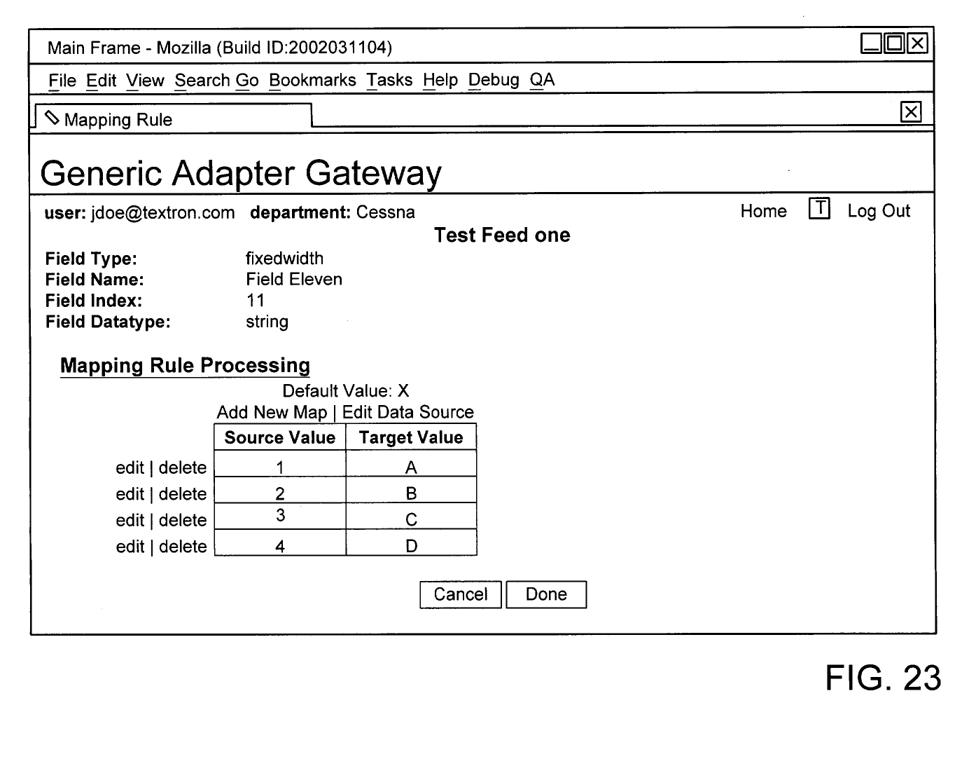

FIG. 23 shows a template permitting the user to define a simple mapping rule. The simple mapping rule permits the user to map values from a data source to other values. It has two parts: The data source, which can be any type of rule; and the mappings, which determine the translation.

The process of evaluation of a simple mapping rule is as follows. When this rule is processed, it gets the current value of the data source (typically a source field). It then looks in the mappings for a “Source Value” that matches the data source value. It then returns the corresponding “Target Value” instead. The user can also set a default value which will be returned if the value from the data source does not match any “Source Values” in the mapping section.

In the example of FIG. 23, the numbers 1, 2, 3, and 4 get converted into A, B, C, and D and the default value is X. The user can use an edit link (lower left-hand corner of the template) to change a mapping, the delete link to remove that mapping, and the Add New Map link to add a mapping. The edit link takes the user to the Configure Data Source template (FIG. 22) where the user can choose the source of data to map. A default link allows the user to set a default value.

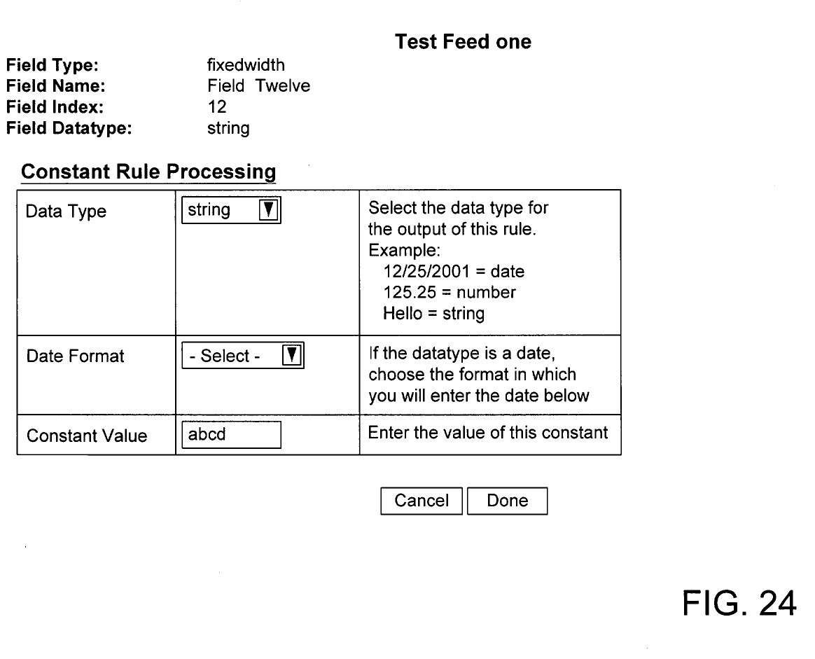

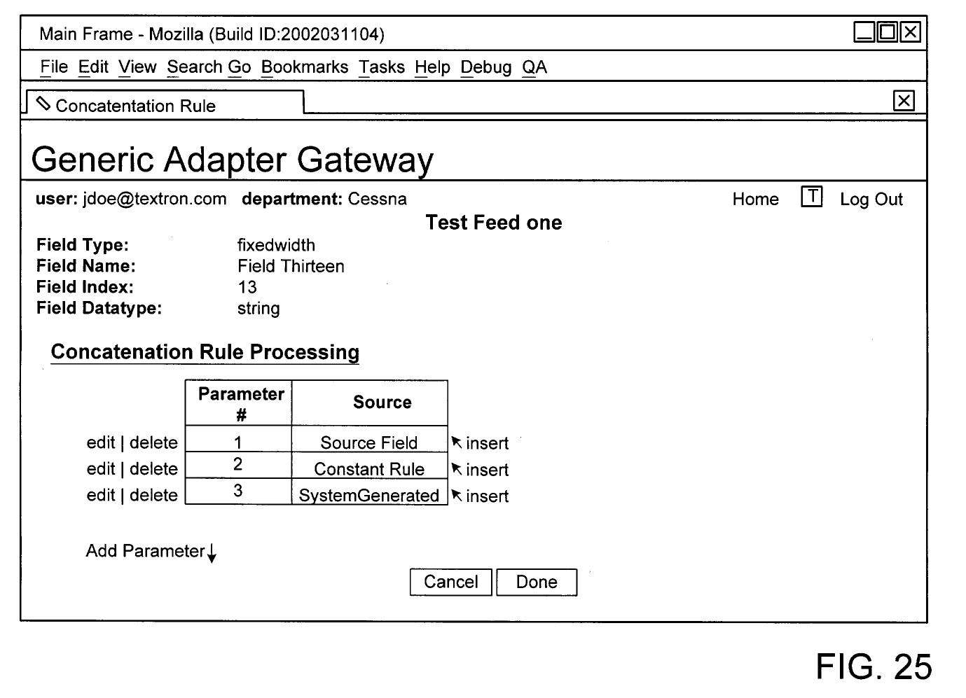

FIG. 24 shows a template permitting the user to define a constant rule. A constant data source rule returns the same thing every time it is evaluated. The value does not depend on anything in the source feed. The value can be a string, a number or a date. The fields available for editing are: Data Type; the data type of the value that this constant rule returns; Date Format; and Value, the data that this constant rule returns as its value. For Date Format, when the data type is Date, then this is the pattern that the system tries to interpret data from the Value field. For example, if a user wants to enter a date in the form MMddyyyy, then the date pattern is selected, and in the Value field, the user would enter 03142002. This would translate as Mar. 14, 2002.

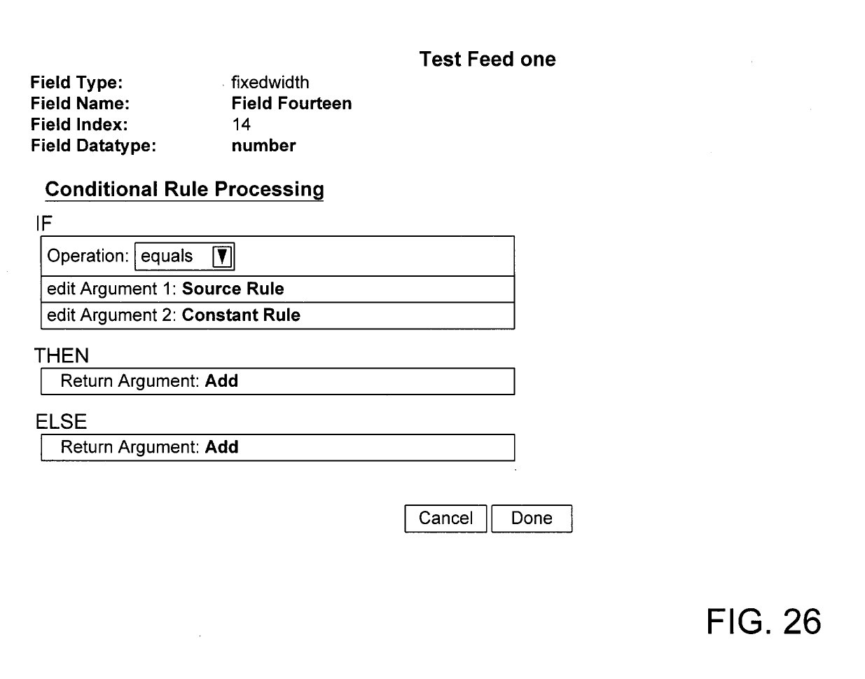

FIG. 25 shows a screen including a template for concatenation rule processing. The concatenation rule allows a user to string together several sub-rules to form one value. For example, if a user had the following rules concatenated together: A constant rule that returned “ABC”, a source field for the Amount field, and a system generated rule that returned the row number; the final value might look something like “BC 123.45122” for one row and “ABC155.32123” for the next.

In the example of FIG. 25, there are no fields to enter on the template. To add a sub-rule to the concatenation, the user clicks on the “Add Parameter” link in the lower left-hand corner. This will take users to the Configure Data Source template, where the user can choose the source of data for this part of the concatenation. To edit an existing data source, the user clicks on the “edit” link, and to delete one, click “delete” next to the data source that is to be deleted. To insert a data source in the middle, the user clicks on the “insert” link on the right hand side, and a new rule will be inserted directly above the line that was clicked.

FIG. 26 shows a conditional rule template. A conditional rule allows some rudimentary logic to be introduced into the target feed. A conditional rule has three major parts: An If statement, an Else statement, and a Then statement. The If statement is a test, which evaluates to either true or false. If the If statement evaluates to true, then the result that gets sent back is the Then statement. If the If statement evaluates to false, then the Else statement value is returned.

The easiest way for a user to fill in the conditional rule template is to define the logic beforehand. For example, assume that the logic is: “If the value of the source field Amount is equal to 0.00, then return the string ZERO, otherwise return the string NONZERO”. In this example, the user chooses the If Operation. In this case, “equals” is the desired operation. Then the user clicks on the “Add” button next to argument one. This takes the user to the Configure Data Source template (FIG. 22). The user chooses “number” in the rule datatype, clicks on “Source Field”, and selects “Amount” from the Source Field drop down. Then the user clicks Done, taking the user back to the conditional rule template of FIG. 26. This is the left-hand side of the test.

Back on the conditional rule template of FIG. 26, the user clicks on the Add button for Argument 2. This will again take the user to the Configure Data Source template (FIG. 22). This time, the user chooses “number” for the data type, chooses “Constant”, and clicks “Done”. This takes the user to the constant rule template (FIG. 24). There, the user chooses number for the data type, enters 0.00 for the value, and then clicks “Done”, taking the user back to the conditional rule template of FIG. 25.

Now the user edits the “Then” and “Else” arguments on the conditional rule template of FIG. 26. For both, the user chooses string “Constants”, with the values outlined above. Evaluation of this rule will check the Amount field and return either ZERO or NONZERO, depending on the value that is in the Amount field.

If more complex logic is required, then the If statement can have nested expressions. If AND or OR is selected as the “If” Operation, then the two arguments are themselves expressions which can have equals, not-equals, and AND or OR operations. This allows for more complex logic sequences if required.

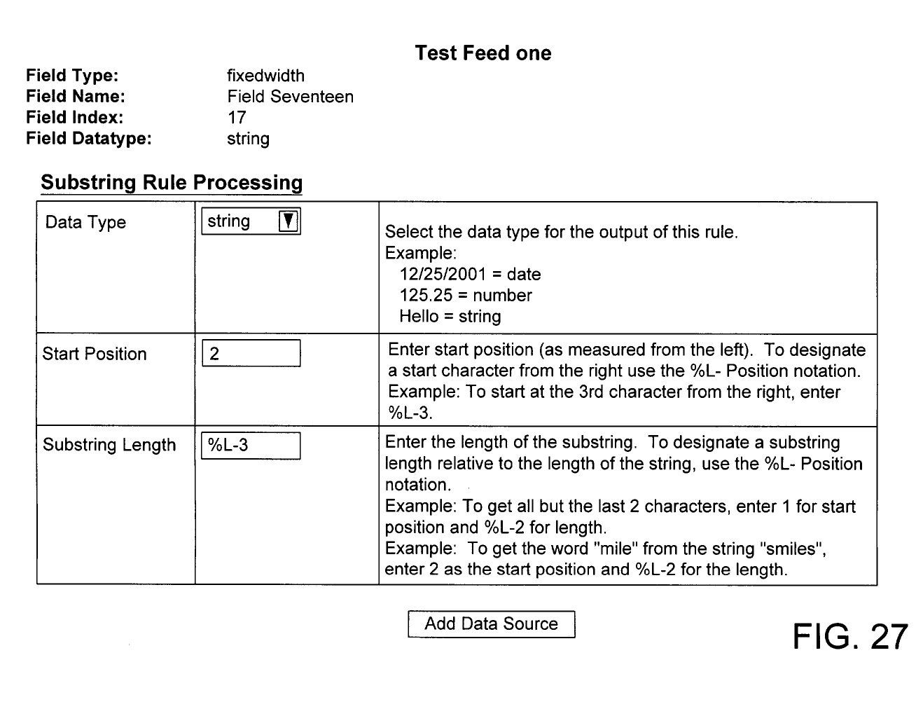

FIG. 27 shows the template for a substring rule. The substring rule allows a user to take a source value and return only a part of it. There are three important fields in the substring rule template: a Data Type field, a Start Position field, and a Substring Length field.

The Data Type field specifies the data type that a user wishes the substring value to be interpreted as. For example, to take the first three characters of the string “123abc”, and to have these first three characters interpreted as a number, the user should choose number for the data type.

The Start Position is the position in the source value at which the substring should be started. For example, with the source value “123abc”, the start position of four would start the substring with the “a” character. In order to calculate the start position relative to the length of the string, i.e. 3 characters from the end, the user can use the form % L-x, where x is the distance from the end (right side) of the string. Using the above source value, a start position of % L-3 would also start with the “a” character. This is useful when the length of the source data is variable.

The Substring Length is the length of the substring, not the end position. For a source value of “123abc”, a start position of 2, and a length of 2, the resulting value would be “23”. The length of the substring can also be calculated relative to the length of the source value. For example, to get all but the first two and last three characters of a string (for example, to get “ppp” from “aapppddd”), the Start Position can be two and the Substring Length can be % L-5.

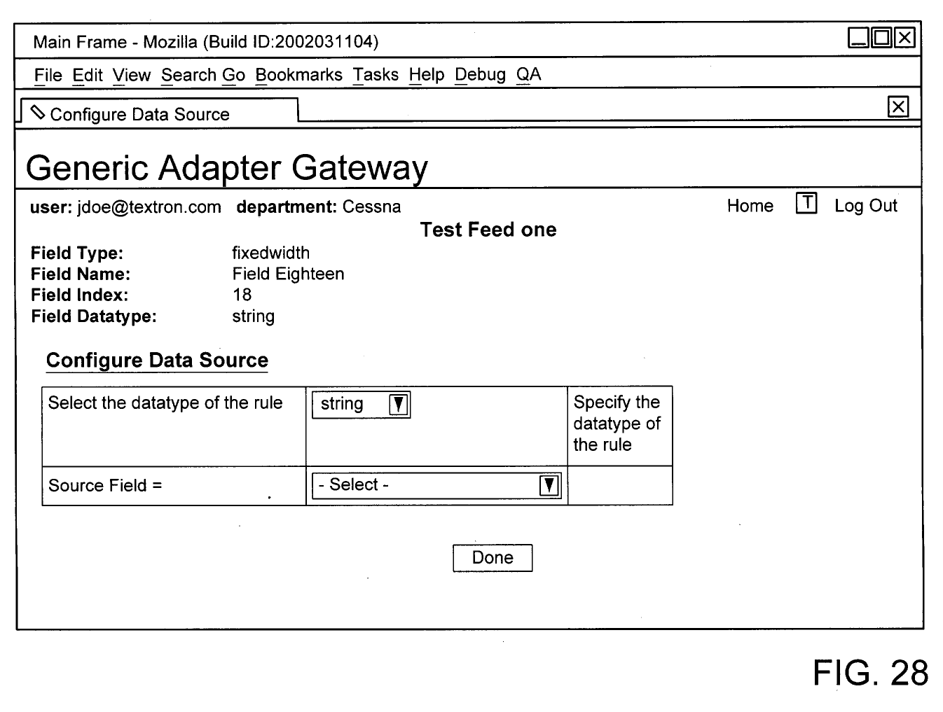

FIG. 28 shows a Configure Data Source template used for defining a Sum Field rule or a Balanced Sum Field rule. These two kinds of rules are used for summing up values for the whole feed. The sum field takes a source field parameter, and when evaluated, tries to loop over the entire set of source data adding up the values. This means that the source field that is selected must be a number. The balance sum field does the same thing, except it negates the resulting sum, for use in balancing records.

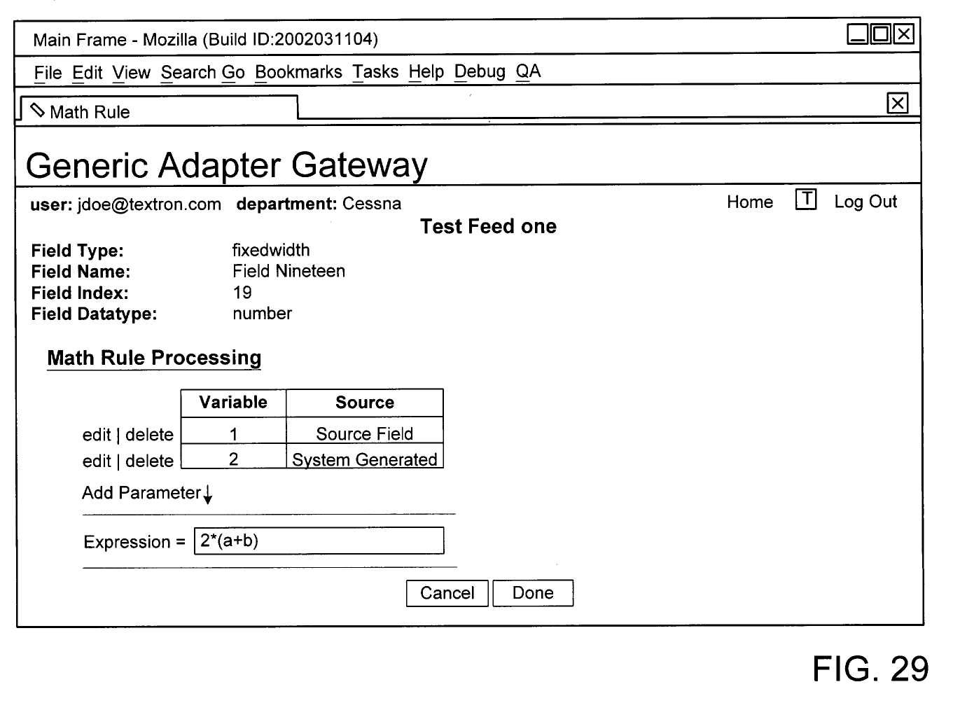

FIG. 29 shows a Math Expression rule template. The Math Expression rule allows the user to perform mathematical expressions using both constant values and values from other rules. There are two components to this rule. The first is the sub-rules, which generate the data. To add a sub-rule to the list, click on the “Add Parameter” link. This will take the user to the Data Source template (FIG. 22), where the user can choose the source of data for this part of the concatenation. To edit an existing data source, click on the “edit” link, and to delete one, click “delete” next to the data source that is to be deleted. The new sub-rule will show up in the list with a variable name next to it. The user is limited to 26 sub-rules.

The second component to the Math Expression rule is the expression. This is the actual mathematical expression that is evaluated when the rule is processed. The mathematical expression may include numbers as well as the variables defined in the list above. For example, if the user added two sub-rules to the Math Expression, they would show up with variable names ‘a’ and ‘b’. The user could then enter an expression such as ‘(2*a)+b’. This would result in the rule representing ‘a’ being evaluated, that value being multiplied by two, and then the result of the rule representing ‘b’ being added. The expression can contain all the standard operators (+, −, *, /) as well as modulus (%), parentheses for order of operations, and the following functions:

ATAN: ArcTangent function which can be used as ATAN(X).

SINH: Sinus Hyperbolic function which can be used as SINH(X).

COSH: Cosinus Hyperbolic function which can be used as COSH(X).

COTAN: which can be used as COTAN(X).

TAN: which can be used as TAN(X).

EXP: which can be used as EXP(X).

LN: natural log, which can be used as LN(X).

LOG: 10 based log, which can be used as LOG(X).

SQRT: which can be used as SQRT(X).

ABS: absolute value, which can be used as ABS(X).

SIGN: SIGN(X) returns −1 if X<0; +1 if X>0, 0 if X=0; it can be used as SQR(X).

TRUNC: Discards the fractional part of a number. e.g. TRUNC(−3.2) is −3, TRUNC(3.2) is 3.

CEIL: CEIL(−3.2)=3, CEIL(3.2)=4.

FLOOR: FLOOR(−3.2)=−4, FLOOR(3.2)=3.

RANDOM: RND(X) generates a random INTEGER number such that 0<=Result <int(X). If X is negative, then result is int(X)<Result <=0.

RANDOM(X) generates a random floating point number such that 0<=Result <X. If X is negative, then result is X<Result <=0.

INTPOW: The INTPOW function raises Base to an integral power. INTPOW(2, 3)=8. Note that result of INTPOW(2, 3.4)=8 as well.

POW: The Power function raises Base to any power. For fractional exponents or exponents greater than MaxInt, Base must be greater than 0.

LOGN: The LogN function returns the log base N of X. Example: LOGN(10, 100)=2.

MIN: MIN(2, 3) is 2.

MAX: MAX(2, 3) is 3.

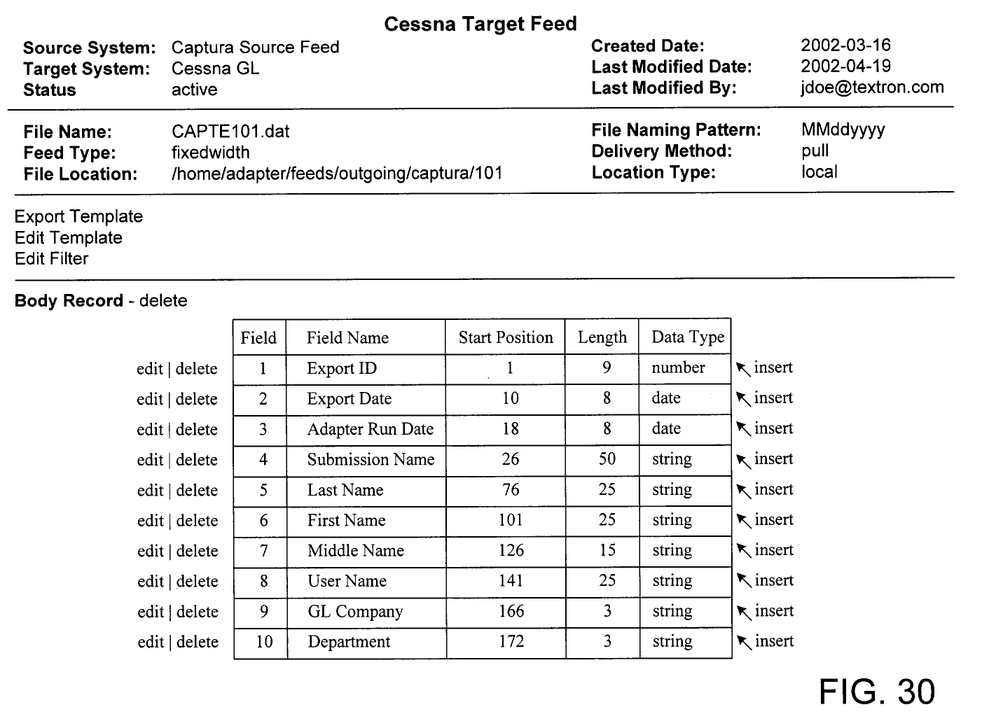

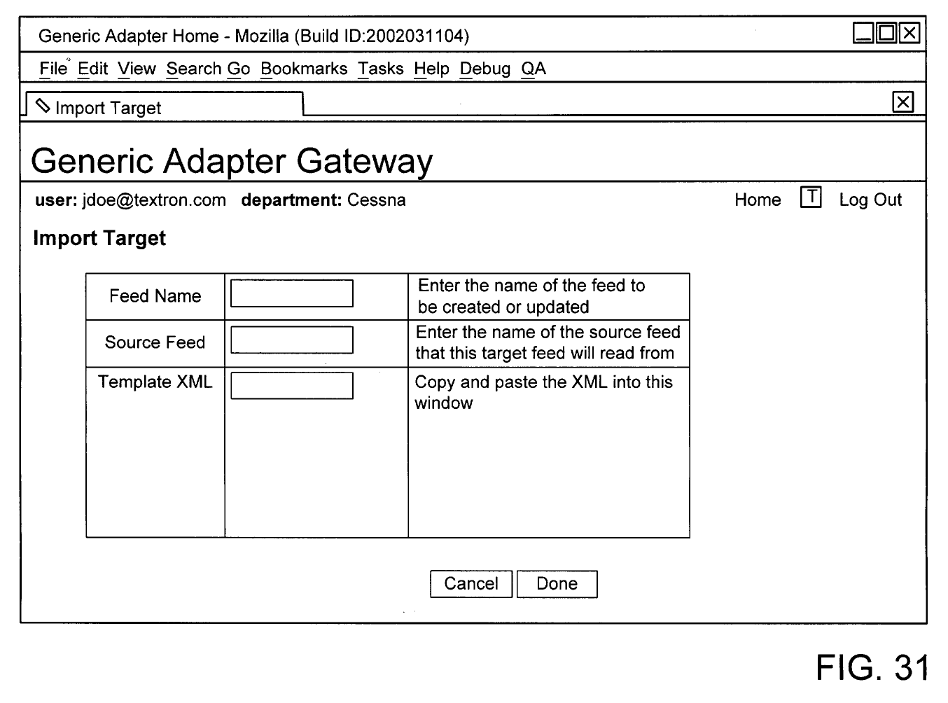

Once a feed has been created, and the feed is selected for editing, then a summary of the feed is displayed, as shown in FIG. 30. The fields of each record are listed and summarized in terms of the field name, start position, length, and data type. Each field can be edited or deleted, and additional fields can be inserted.

The user can duplicate a target feed by selecting the “Duplicate” Icon on the generic adapter home page (FIG. 13) at the end of the listing of the target feed. This will create an identical “saved” copy of the feed renamed as “Copy of {feed name} ”. This allows the user to create multiple feeds with only minor differences without having to reproduce the entire feed.

The user can import a target feed by Clicking on the Import Target link on the Home page (In FIG. 13, left-hand side above listing of inactive target feeds) will take the user to the Import Target page, as shown in FIG. 31. This will allow the user to create a new feed, or update an existing feed, with an existing XML feed layout document. There are three fields on this page that must be filled out: Feed Name, Source Feed, and Template XML. The Feed Name is the name of the feed to be created or updated. If the name of the feed is the same as an existing feed, then this is treated as an update. If the name does not exist, then it treats it as an insert. Source Feed is the name of the source feed that this target feed will read from. Template XML is the XML for the template. The user should copy and paste the XML from a local file into this window.

When in the Feed Summary page of any feed (e.g., FIG. 30), clicking on the Export Template link will bring up a download window that prompts the user to save an XML file to the user's local disk. This file contains the XML representation of the current template. This file can be used as a backup for feed layouts and can be managed internally.

Once a change is made to the feed configuration, the changes reside in the system memory until the user clicks on the “save” button. If a user exits the system without saving, or opens a feed without saving changes to a previous one, the latest changes will be lost. The simplest way to avoid lost data is to save frequently. Saving a feed does not validate it; it merely stores it in the database for future editing. These feeds are assumed to be incomplete and cannot be executed.

Saved feeds can be verified to ensure feed integrity. Some of the validation checks include verifying the overall field layouts, checking for missing required field inputs, invalid entries etc. Clicking the “Verify” button will validate the feed and report back either a list of errors or successful message.

Once a feed is verified it enters a deactivated status and remains that way until activated. Any subsequent changes to the feed will need to be verified once more before activating a feed.

Verified feeds can exist as active or inactive feeds. Active feeds are those that are complete and will be processed by the batch process (This is only true for wildcard batch processes; if the batch command explicitly runs the named feed, it will override the active/inactive status). An inactive feed can be activated by selecting the “activate” button and deactivated by selecting the “deactivate” link. Any changes to an active or inactive feed will require the feed to be saved, verified and activated once more.

The feed preview functionality allows the user to create a preview feed of an active or inactive feed. The output is in the form of a file, which can be saved and processed on a user's target system. The data represented in the preview is from the latest batch run and will only show records specific to that target feed. Therefore, if no records exist that match the filter criteria, a “No Records Available” message will be displayed. This does not represent an error.

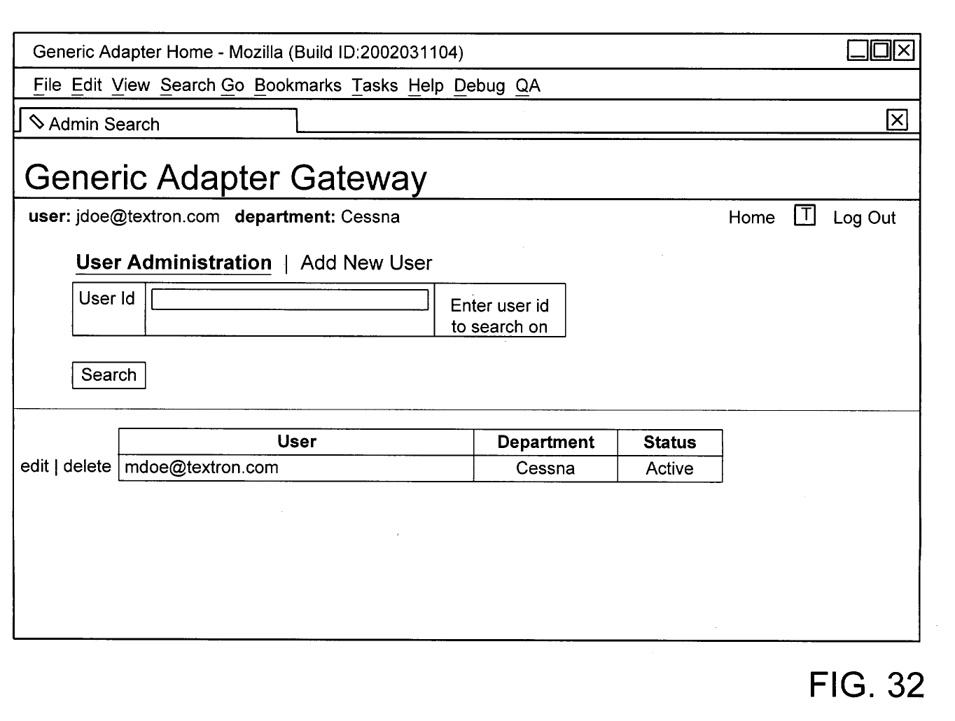

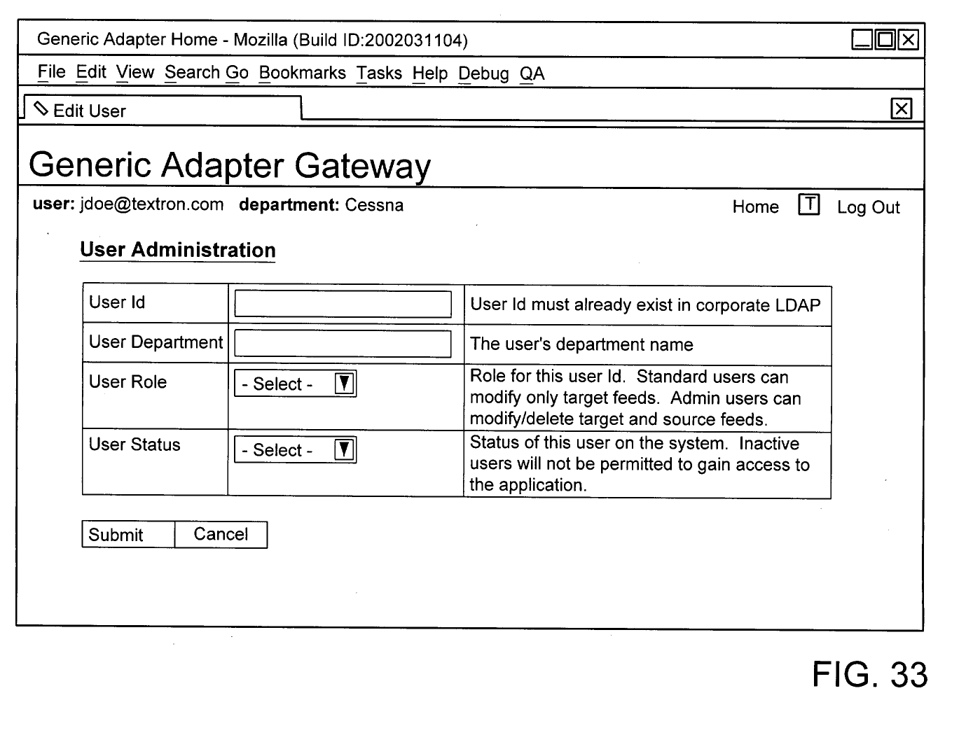

The administrator can access an administration section, which includes a search page as shown in FIG. 32, and an add/edit user page as shown in FIG. 33. The search page of FIG. 32 has one field, which allows the administrator to type in all or part of a user's email address and get back a list of results. From here the administrator can edit or delete users by clicking on the “edit” or “delete” links. The administrator can also click on the Add New User link, which will take the administrator to the add/edit user page of FIG. 33.

The add/edit user page of FIG. 33 has a User ID field, a User Department field, a User Role field, and a User Status field. The User ID is the user's email address. The User Department is the user's department or division name. The User Role field indicates whether the user is a standard user or an administrator. A standard user can edit target feeds that belong to their own division, and cannot edit source feeds. An administrator can edit all target and source feeds. The User Status is active or inactive. An inactive user cannot log into the generic adapter.

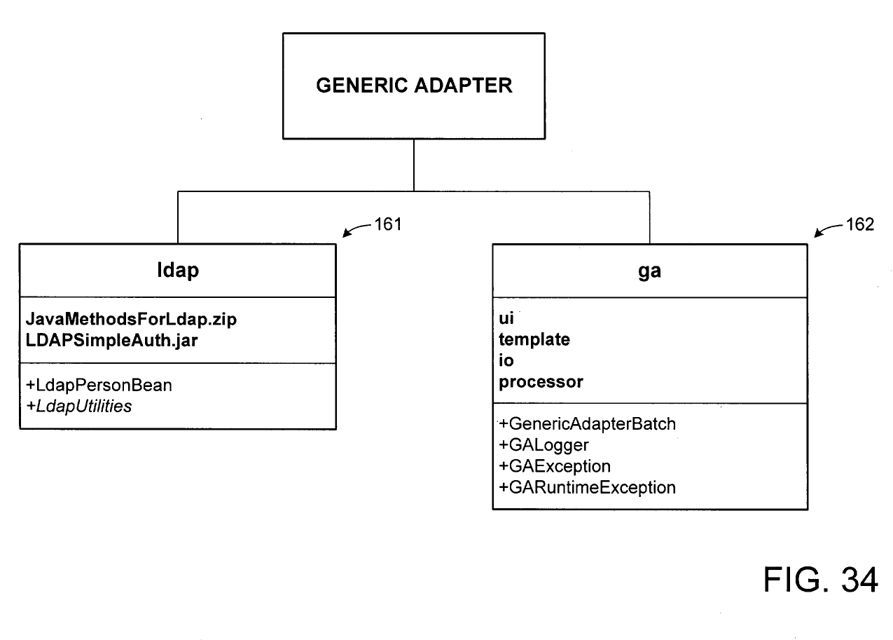

FIG. 34 shows a hierarchy of objects in the preferred object-oriented programming of the generic software adapter. In the preferred embodiment, the programming is in the Java programming language. The objects are divided into two groups, “ldap” objects (161) and “ga” objects (162). The “ldap” objects relate to maintenance of a user directory, and access to the user directory for authentication and authorization of a user for access to the generic software adapter. The “ga” objects relate to the generic software adapter, other than maintenance of the user directory and user authentication and authorization for access.

The “ldap” objects (161) administer user access by maintaining a directory of user information. The objects are subdivided into objects that define the user directory (JavaMethodsForLdap.zip) and objects for using the directory for authorizing user access to the generic software adapter (LDAPSSimpleAuth.jar).

The LdapPersonBean includes methods that add a new user to the directory, authenticate an administrative user to the directory, authenticates a user to the user directory, check for password expiration, create a connection to the server based on the host name and port passed in, add a domain to the list of portal domains that a user is allowed to access, set the password attribute of a connection, and validate data before it is written to the user database. The LdapPersonBean also includes methods that delete an object from the directory, and access specified fields of user data in the user directory. The fields of user data in the user directory include address line 1, address line 2, cell phone number, city, user's common name, user's country, user's department number, user's description, user's distinguished name, user's email address, user's employee number, employee type, fax number, first name, last name, organizational unit, pager phone number, portal domains, preferred language, state, title, password question, password response, ID, and zip code.

The LdapUtilities include utilities that add a new user to the user directory, authenticate a user, authenticate an administrative user, delete an object or entry from the user directory, initialize an object, initialize all members of the object from the data store, attempt to locate a user based on user ID, set the password attribute of a connection, perform a search in the directory based on the filter passed in, update an entry in the data store with values from a person object, update an attribute within the directory server, and validate data before it is written into the directory server.

The “ga” objects (162) include user interface (ui) objects that implement the administration tool (103 in FIG. 6), “template” objects that implement the templates and rules (105 in FIG. 6) and the formatting engine (102 in FIG. 6), the “io” objects implement the feed database (104 in FIG. 6), and the “processor” objects implement the transformation engine (101 in FIG. 6). The “ga” methods include GenericAdapterBatch, which provides for nightly batch process, GALogger, which provides logging functionality, and GAException and GARuntimeException, which provide for customized exceptions.

The user interface (ui) subclasses include AdminRequestHandlerImpl, which handles all the requests for the admin screens; BaseRequestHandlerImpl, which provides base functionality for all the request handler classes; ConditionalRequestHandlerImpl, which handles requests dealing with the conditional class; DatabaseXSLURIResolver, which resolves requests for XSL URIs, for xsl: include and xsl: import statements; DataSourceRequestHandlerImpl, which handles requests for creating and editing data sources; ExpressionReqUestHandlerImpl, which handles requests dealing with the expression class; FeedSummaryRequestHandlerImpl, which handles requests for a feed summary page; FieldRequestHandlerImpl, which handles requests to view and edit fields; HomePageRequestHandlerImpl, which provides the data needed to generate the user home page; RequestHandler, which is an interface that should be implemented by any class wishing to handle a request from the AdminController servlet; RequestHandlerRequest, which wraps an HttpServletRequest, and merges the attributes and the parameters; and RequestHandlingException, which handles an exception while accessing the Database. The user interface (ui) subclasses also has a number of sub-classes for handling the various field rules, including the subclasses MappingRequestHandlerImpl, SubstitutionRequestHandlerImpl, SubstringRequestHandlerImpl, and SumFieldRequestHandlerImpl. The user interface (ui) subclasses also include a NavTreeRequeStHandlerImpl for navigating a tree data structure.

The template subclasses include BalanceSumFieldRuleDefinitionImpl, which implements balance sum field rules; ConcatenationRuleDefinitionImpl, which implements concatenation rules; ConditionalRuleDefinitionImpl, which implements conditional rules; ConstantRuleDefinitionImpl, which implements constant rules; DateFormatterImpl, which applies formatting to date values; DelimitedFileFieldDefinitionImpl, which is an implementation of the FieldDefinition object for delimited files; DelimitedFileTemplateValidatorImpl, which validates a fixed-width, file-based template; ExpressionRuleDefinitionImpl, which works in conjunction with the ConditionalRuleDefinitionImpl class; FieldDefinition, which is an interface that abstracts the definition of a field definition; FieldDefinitionFactory, which is a factory class for creating FieldDefinition objects; FieldDefinitionImpl, which is a base class for all field definitions; FilterDefinition, which is an interface defining a set of rules which can be used to filter the source data set; FilterDefinitionImpl, which implements a Filter Definition, FixedFileFieldDefinitionImpl, which is an implementation of the FieldDefinition object for fixed-width files; FixedWidthFileTemplateValidatorImpl, which validates a fixed-width, file-based template; Formatter, which is an interface representing classes that perform formatting operations on values; FormatterFactory, which is a factory class for creating Formatter objects; FormatterImpl, which is the base class for all the formatting classes; FormattingException, which represents an error during the evaluation of a rule; MappingRuleDefinitionImpl, which is a simplification of the conditional class; NumberFormatterImpl, which applies number formatting to a particular value; RecordDefinition, which is an interface defining access to a record definition; RuleDefinition, which defines a generic interface to a rule definition; RuleDefinitionFactory, which is a factory class for creating RuleDefinition objects; RuleDefinitionImpl, which is the base class for all the rule definition classes; RuleEvaluationException, which represents an error during the evaluation of a rule; SourceFieldRuleDefinitionImpl, which implements the source field rules (which indicates that a value from one of the source fields from the database should be returned when this rule is evaluated); SourceTemplateDefinition, which is an interface extending the TemplateDefinition interface to provide functions specific to source data feeds; SourceTemplateDefinitionImpl, which extends the TemplateDefinitionImpl class to provide functionality specific to source templates, namely the ability to get a data source reader; StringFormatterImpl, which implements the string formatting rules; SubstringRuleDefinitionImpl, which implements the substring rules; SumFieldRuleDefinitionImplm, which implement the sum field rules; SystemGeneratedRuleDefinitionImpl, which provides system-generated data feeds, such as current date/time, current row number, total row number, etc.; TargetTemplateDefinition, which is an interface extending the TemplateDefinition interface to provide functions specific to target data feeds; TargetTemplateDefinitionImpl, which extends the TemplateDefinitionImpl class to provide functions specific to target data feeds; TemplateConstructionException, which represents an error during the construction of the template; TemplateDefinition, which is the base interface for a template definition; TemplateDefinitionImpl, which is the base implementation of a Feed Definition; TemplateObject, which is an interface that is shared among all objects that make up a Source or Target template; TemplateValidator, which is a class performing validation on a template as a whole; TemplateValidatorFactory, which is a factory class for creating TemplateValidator objects; ValidationException, which represents an error during the evaluation of a rule; XMLException, which represents an error during the construction of the template; XMLRuntimeException, which represents an error during the construction of the template; and XMLUtilities, which provides several XML utility functions.

The “io” subclasses include DatabaseAccess, which provides convenience functions for accessing the database; DatabaseAccessException, which represents an error while accessing the Database; DatabaseAccessImpl, which provides data access abstraction; DelimitedFileFeedDataSourceReaderImpl, which provides for reading a delimited file feed data source; DelimitedFileFeedDataSourceWriterImpl, which provides for writing a delimited file feed data source; DelimitedStreamFeedDataSourceWriterImpl, which provides for writing a delimited feed data source; DisconnectedResultSet, which provides a way to disconnect a resultset from the database connection; FeedDataSource FeedDataSourceException, which represents an error during feed operations; FeedDataSourceFactory, which is a factory for creating FeedDataSource objects; FeedDataSourceReader, which provides for reading a feed data source; FeedDataSourceWriter, which provides for writing a feed data source; FileFeedDataSourceImpl, which implements the FeedDataSource interface for fixed-width flat file feeds; FixedFileFeedDataSourceReaderImpl, which provides for reading fixed-width flat file feeds; FixedFileFeedDataSourceWriterImpl, which provides for writing fixed-width flat file feeds; FixedStreamFeedDataSourceWriterImpl, which provides for writing fixed-width flat file feed streams; and StreamFeedDataSourceImpl, which implements the FeedDataSource interface for fixed-width flat file feeds.

The processor subclasses include SourceProcessor, which is the remote interface to the SourceProcessorBean SSB; SourceProcessorBean, which is responsible for retrieving the source data feed from its original state, processing it, and loading it into the database in preparation for the creation of target feeds; TargetProcessorBean, which implements the functionality of the TargetProcessor SSB; and TemplateProcessingException, which represents an error during the processing of the template.

In view of the above, there has been described a generic software adapter that eliminates platform restrictions and reduces complexity in the fulfillment of integration needs. The generic adapter provides a single executable that generates at one time all necessary transformations from a source feed to a target feed. The executable code is separate from the knowledge base defining the transformations. In a preferred implementation, the knowledge base includes stored template information with no need for updating unless there is change in the format of the source or target feed. A graphical user interface displays a series of templates to the user in order to collect the template information. The templates provide non-technical staff with the ability to administer the integration process by way of an easy-to-use web interface using no client other than a web browser. Moreover, the stored templates can be easily modified for an upgrade or for integrating an existing source feed with a new target feed or an existing target feed with a new source feed.

APPENDIX I
Captura Source Feed - Source XML Template.xml

```
<?xml version=“1.0” encoding=“UTF-8” ?>
- <!-- edited with XML Spy v4.1 U (http://www.xmlspy.com) by Giora
Morein
(Back Bay Technologies) -->
- <template xmlns:xsi=“http://www.w3.org/2001/XMLSchema-instance”
  xsi:schemaLocation=“http://www.textron.com/GenericAdapter
  C:\clients\Textron\04-Construction\xml\GATemplate.xsd”
  type=“source”
    name=“Captura Source Feed” status=“active”>
  - <datasource type=“fixedwidth” encoding=“UTF-8”>
    - <location type=“local”>
        <directory>c:\temp</directory>
    </location>
    <filename>captura.dat</filename>
    <datepattern>MMddyyyy</datepattern>
    <append>no</append>
  </datasource>
- <sections>
  - <header>
    - <record>
      - <field name=“Head Format Indicator” datatype=“string”>
        <startpos>1</startpos>
        <length>2</length>
      - <formatting xsi:type=“string-formatting” type=“string”>
        <length>2</length>
        </formatting>
        <assert>HH</assert>
      </field>
      - <field name=“Header Description” datatype=“string”>
        <startpos>13</startpos>
        <length>32</length>
  - <formatting xsi:type=“string-formatting” type=“string”>
    <length>32</length>
  </formatting>
  </field>
- <field name=“ExportID Indicator” datatype=“string”>
    <startpos>55</startpos>
    <length>9</length>
    - <formatting xsi:type=“string-formatting” type=“string”>
      <length>9</length>
    </formatting>
  </field>
- <field name=“ExportID” datatype=“string”>
    <startpos>64</startpos>
    <length>9</length>
    - <formatting xsi:type=“string-formatting” type=“string”>
      <length>9</length>
    </formatting>
  </field>
- <field name=“Export Date” datatype=“date”>
    <startpos>73</startpos>
    <length>8</length>
  - <formatting xsi:type=“date-formatting” type=“date”>
      <length>8</length>
        <date-pattern-in>yyyyMMdd</date-pattern-in>
        <date-pattern-out>MMddyyyy</date-pattern-out>
      </formatting>
    </field>
  </record>
</header>
```

1. A software adapter for transforming source data in a source data format to target data in a target data format, said software adapter comprising, in combination;
a graphical user interface for obtaining from the user a plurality of rules specifying how to transform the source data from the source data format to the target data in the target data format, the graphical user interface being programmed for obtaining the rules from the user by presenting to the user a series of templates that are filled in by the user;
a rule database coupled to the graphical user interface for storing the rules; and
at least one engine coupled to the rule database for accessing the rule database for interpreting the rules in order to transform the source data in the source data format to the target data in the target data format.

2. The software adapter as claimed in claim 1, wherein the graphical user interface is programmed to function as a web server for serving a web browser of the user when obtaining the rules from the user.

3. The software adapter as claimed in claim 1, wherein the rules include mapping rules, constant rules, concatenation rules, conditional rules, and substring rules.

4. The software adapter as claimed in claim 1, wherein the templates include a template for mapping rules, a template for constant rules, a template for concatenation rules, a template for conditional rules, a template for substring rules, and a template for math rules.

5. The software adapter as claimed in claim 1, wherein the rules as stored in the rule database are the templates that have been filled in by the user.

6. The software adapter as claimed in claim 1, wherein the graphical user interface is programmed to display to the user status of a plurality of source and target data formats, the status including an indication of source and target data formats that are saved and an indication of source and target data formats that are active.

7. The software adapter as claimed in claim 1, wherein the graphical user interface is programmed to permit the user to configure a new data format by specifying fields for the new data format, and by specifying a datatype and source for each field.

8. The software adapter as claimed in claim 7, wherein the graphical user interface is programmed to display to the user a template for configuring a field of a string datatype, a template for configuring a field of a number datatype, and a template for configuring a field of a date datatype.

9. The software adapter as claimed in claim 7, wherein the graphical user interface is programmed to display to the user a template for configuring the source for each field, and indicating whether or not the source for each field is a rule or is system generated.

10. The software adapter as claimed in claim 1, wherein the source data format is a file format, and the target data format is a file format.

11. The software adapter as claimed in claim 1, which includes:
a feed database for storing a specification of the source data format and a specification of the target data format;
a formatting engine coupled to the rule database for accessing the rule database and interpreting the rules; and
a transformation engine coupled to the feed database and the formatting engine for transforming the source data in the source data format to the target data in the target data format in accordance with the specification of the source data format, the specification of the target data format, and the rules.

12. The software adapter as claimed in claim 11, wherein the specification of the source data format specifies a plurality of source fields and a datatype for each source field, and the specification of the target data format specifies a plurality of target fields and a datatype of each target field.

13. The software adapter as claimed in claim 11, wherein the specification of the source data format is written in extensible markup language, and the specification of the target data format is written in extensible markup language.

14. A software adapter for transforming source data in a source data format to target data in a target data format, said software adapter comprising, in combination;
a graphical user interface for obtaining from the user a plurality of rules specifying how to transform the source data from the source data format to the target data in the target data format;
a rule database coupled to the graphical user interface for storing the rules;
a transformation engine coupled to the rule database for accessing the rule database for interpreting the rules;
a feed database for storing a specification of the source data format and a specification of the target data format; and
a transformation engine coupled to the feed database and the formatting engine for transforming the source data in the source data format to the target data in the target data format in accordance with the specification of the source data format, the specification of the target data format, and the rules.

15. The software adapter as claimed in claim 14, wherein the specification of the source data format specifies a plurality of source fields and a datatype for each source field, and the specification of the target data format specifies a plurality of target fields and a datatype for each target field.

16 The software adapter as claimed in claim 14, wherein the source data format is a file format, and the target data format is a file format.

17. The software adapter as claimed in claim 14, wherein the specification of the source data format is written in extensible markup language, and the specification of the target data format is written in extensible markup language.

18. The software adapter as claimed in claim 14, wherein the graphical user interface is programmed for obtaining the specification of the source data format and the specification of the target data format from the user by presenting a series of templates to the user that the user fills in.

19. The software adapter as claimed in claim 14, wherein the graphical user interface is programmed for obtaining the plurality of rules from the user by presenting a series of templates that the user fills in to specify the plurality of rules.

20. The software adapter as claimed in claim 19, wherein the templates include a template for mapping rules, a template for constant rules, a template for concatenation rules, a template for conditional rules, a template for substring rules, and a template for math rules.

21. The software adapter as claimed in claim 14, wherein the rules include mapping rules, constant rules, concatenation rules, conditional rules, and substring rules.

22. The software adapter as claimed in claim 14, wherein the graphical user interface is programmed to function as a web server for serving a web browser of the user when obtaining from the user the plurality of rules specifying the source data format and the target data format.

23. The software adapter as claimed in claim 14, wherein the rules as stored in the rule database are templates that have been filled in by the user.

24. The software adapter as claimed in claim 14, wherein the source data format includes a plurality of records, and the graphical user interface is programmed to allow the user to choose filtering of the records of the source data format from which the source data is transformed to the target data.

25. A program storage device containing a program executable by at least one data processor for transforming source data in a source data format to target data in a target data format,
wherein the program is executable for obtaining from the user a plurality of rules specifying how to transform the source data from the source data format to the target data in the target data format, the program being executable for obtaining the rules from the user by presenting to the user a series of templates that are filled in by the user;
wherein the program is executable for storing the rules in a rule database; and
wherein the program is executable for accessing the rule database for interpreting the rules in order to transform the source data in the source data format to the target data in the target data format.

26. The program storage device as claimed in claim 25, wherein the program is executable to function as a web server for serving a web browser of the user when obtaining from the user the plurality of rules specifying the source data format and the target data format.

27. The program storage device as claimed in claim 25, wherein the rules include mapping rules, constant rules, concatenation rules, conditional rules, substring rules, and math rules.

28. The program storage device as claimed in claim 25, wherein the templates include a template for mapping rules, a template for constant rules, a template for concatenation rules, a template for conditional rules, a template for substring rules, and a template for math rules.

29. The program storage device as claimed in claim 25, wherein the rules as stored in the rule database are the templates that have been filled in by the user.

30. The program storage device as claimed in claim 25, wherein the program is executable for displaying to the user status of a plurality of source and target data formats, the status including an indication of source and target data formats that are saved and an indication of source and target data formats that are active.

31. The program storage device as claimed in claim 25, wherein the program is executable for permitting the user to configure a new data format by specifying fields for the new data format, and by specifying a datatype and source for each field.

32. The program storage device as claimed in claim 31, wherein the program is executable for displaying to the user a template for configuring a field of a string datatype, a template for configuring a field of a number datatype, and a template for configuring a field of a date datatype.

33. The program storage device as claimed in claim 31, wherein the program is executable for displaying to the user a template for configuring the source for each field, and indicating whether or not the source for each field is a rule or is system generated.

34. The program storage device as claimed in claim 25, wherein the source data format is a file format, and the target data format is a file format.

35. The program storage device as claimed in claim 25, wherein the source data format includes a plurality of records, and the program is executable to allow the user to choose filtering of the records of the source data format from which the source data is transformed to the target data.

36. A program storage device containing a program executable by at least one data processor for transforming source data in a source data format to target data in a target data format,
wherein the program is executable for obtaining from the user a specification of the source data format and a specification of the target data format,
wherein the program is executable for obtaining from the user a plurality of rules specifying how to transform the source data from the source data format to target data in the target data format, and
wherein the program is executable for transforming the source data in the source data format to the target data in the target data format in accordance with the specification of the source data format, the specification of the target data format, and the rules.

37. The program storage device as claimed in claim 36, wherein the specification of the source data format specifies a plurality of source fields and a datatype for each source field, and the specification of the target data format specifies a plurality of target fields and a datatype for each target field.

38. The program storage device as claimed in claim 36, wherein the source data format is a file format, and the target data format is a file format.

39. The program storage device as claimed in claim 36, wherein the specification of the source data format is written in extensible markup language, and the specification of the target data format is written in extensible markup language.

40. The program storage device as claimed in claim 36, wherein program is executable for obtaining the specification of the source data format and the specification of the target data format from the user by presenting a series of templates to the user that the user fills in.

41. The program storage device as claimed in claim 36, wherein the program is executable for obtaining the rules from the user by presenting a series of templates that the user fills in to specify the rules.

42. The program storage device as claimed in claim 41, wherein the templates include a template for mapping rules, a template for constant rules, a template for concatenation rules, a template for conditional rules, a template for substring rules, and a template for math rules.

43. The program storage device as claimed in claim 36, wherein the rules include mapping rules, constant rules, concatenation rules, conditional rules, and substring rules.

44. The program storage device as claimed in claim 36, wherein the program is executable for functioning as a web server for serving a web browser of the user when obtaining from the rules from the user.

45. The program storage device as claimed in claim 36, wherein the program is executable for storing the rules in a rule database, and the rules as stored in the rule database are templates that have been filled in by the user.

46. The program storage device as claimed in claim 36, wherein the source data format includes a plurality of records, and the program is executable for allowing the user to choose filtering of the records of the source data format from which the source data is transformed to the target data.

47. A method of transforming source data in a source data format to target data in a target data format, said method comprising:
obtaining from the user a plurality of rules specifying how to transform the source data from the source data format to the target data in the target data format, the rules being obtained from the user by presenting to the user a series of templates that are filled in by the user;
storing the rules in a rule database; and
operating at least one data processor for accessing the rule database for interpreting the rules in order to transform the source data in the source data format to the target data in the target data format.

48. The method as claimed in claim 47, wherein the user operates a web browser when the rules are obtained from the user.

49. The method as claimed in claim 47, wherein the rules include mapping rules, constant rules, concatenation rules, conditional rules, substring rules, and math rules.

50. The method as claimed in claim 47, wherein the templates include a template for mapping rules, a template for constant rules, a template for concatenation rules, a template for conditional rules, a template for substring rules, and a template for math rules.

51. The method as claimed in claim 47, wherein the rules as stored in the rule database are the templates that have been filled in by the user.

52. The method as claimed in claim 47, which includes displaying to the user status of a plurality of source and target data formats, the status including an indication of source and target data formats that are saved and an indication of source and target data formats that are active.

53. The method as claimed in claim 47, which includes the user configuring a new data format by specifying fields for the new data format, and by specifying a datatype and source for each field.

54. The method as claimed in claim 53, which includes displaying to the user a template for configuring a field of a string datatype, a template for configuring a field of a number datatype, and a template for configuring a field of a date datatype.

55. The method as claimed in claim 53, which includes displaying to the user a template for configuring the source for each field, and indicating whether or not the source for each field is a rule or is system generated.

56. The method as claimed in claim 47, wherein the source data format is a file format, and the target data format is a file format.

57. The method as claimed in claim 47, wherein the source data format includes a plurality of records, and the user chooses filtering of the records of the source data format from which the source data is transformed to the target data.

58. A method of transforming source data in a source data format to target data in a target data format, said method comprising:
obtaining from the user a specification of the source data format and a specification of the target data format,
obtaining from the user a plurality of rules specifying how to transform the source data from the source data format to the target data in the target data format, and
operating at least one data processor for transforming the source data in the source data format to the target data in the target data format in accordance with the specification of the source data format, the specification of the target data format, and the rules.

59. The method as claimed in claim 58, wherein the specification of the source data format specifies a plurality of source fields and a datatype for each source field, and the specification of the target data format specifies a plurality of target fields and a datatype for each target field.

60. The method as claimed in claim 59, which includes operating a graphical user interface enabling the user to edit, delete, and insert fields into the specification of the source and target data format.

61. The method as claimed in claim 58, wherein the source data format is a file format, and the target data format is a file format.

62. The method as claimed in claim 58, wherein the specification of the source data format is written in extensible markup language, and the specification of the target data format is written in extensible markup language.

63. The method as claimed in claim 58, which includes obtaining the specification of the source data format and the specification of the target data format from the user by presenting a series of templates to the user that the user fills in.

64. The method as claimed in claim 63, which includes storing the templates in a database, and the user later editing the templates in order to transform data to or from a new data format.

65. The method as claimed in claim 63, wherein the templates include a template for specifying a datatype for each field.

66. The method as claimed in claim 65, wherein the datatypes include a string datatype, a number datatype, and a date datatype.

67. The method as claimed in claim 63, wherein the templates include a template for specifying a source for each field.

68. The method as claimed in claim 67, wherein the templates include a template for specifying that the source for a field is a rule.

69. The method as claimed in claim 67, wherein the templates include a template for specifying that the source for a field is system generated.

70. The method as claimed in claim 58, which includes obtaining the rules from the user by presenting a series of templates that the user fills in to specify the rules.

71. The method as claimed in claim 70, wherein the templates include a template for mapping rules, a template for constant rules, a template for concatenation rules, a template for conditional rules, a template for substring rules, and a template for math rules.

72. The method as claimed in claim 58, wherein the rules include mapping rules, constant rules, concatenation rules, conditional rules, and substring rules.

73. The method as claimed in claim 58, which includes the user operating a web browser when the rules are obtaining from the user.

74. The method as claimed in claim 58, which includes storing the rules in a rule database, wherein the rules as stored in the rule database are templates that have been filled in by the user.

75. The method as claimed in claim 58, wherein the source data format includes a plurality of records, and the user chooses filtering of the records of the source data format from which the source data is transformed to the target data.

76. A software adapter for transforming source data in a source data format to target data in a target data format, said software adapter comprising, in combination;
input means for obtaining from the user a specification of the source data format, a specification of the target data format, and a plurality of rules specifying how to transform the source data from the source data format to the target data in the target data format;
a memory for storing the specification of the source data format, the specification of the target data format, and the rules; and
at least one processor coupled to the memory for transforming the source data in the source data format to the target data in the target data format by accessing the memory and interpreting the rules in accordance with the specification of the source data format and the specification of the target data format.

77. The software adapter as claimed in claim 76, wherein the input means includes means for presenting to the user a series of templates that the user fills in to input the specification of the source data format, the specification of the target data format, and the rules specifying how to transform the source data from the source data format to the target data format.

78. The software adapter as claimed in claim 77, therein the templates include at least one template for displaying the source or target data format, at least one template for configuring a new source or target data format, at least one template for specifying source data for the target data format, and templates for specifying various kinds of rules.

79. The software adapter as claimed in claim 76, wherein the specification of the source data format defines a series of source fields and a datatype of each source field, the specification of the target data format defines a series of target fields and a datatype of each target field, and the rules include rules having specified ones of the source fields as input, and rules having specified ones of the target fields as output.
